(19) United States
(12) Patent Application Publication
(10) Pub. No.: US 2010/0291822 A1
(43) Pub. Date: Nov. 18, 2010

(54) STARCH BASED COMPOSITES AND PROCESS OF MANUFACTURE

(76) Inventor: Anil Netravali, Ithaca, NY (US)

Correspondence Address: Jaekle Fleischmann & Mugel, LLP, 12 Fountain Plaza, Buffalo, NY, 14202-2292, US

(21) Appl. No.: 12/782,583

(22) Filed: May 18, 2010

Related U.S. Application Data
(60) Provisional application No. 61/179,252, filed on May 18, 2009.

(51) Int. Cl. B32B 23/04; B05D 3/02; B32B 23/06; B32B 29/06; D01F 2/24; D03D 25/00; D04H 13/00

(52) U.S. Cl. 442/153; 427/382; 428/533

(57) ABSTRACT

In one aspect of the invention, there is a biodegradable composition comprising lignocellulosic reinforcement material impregnated with a starch based resin and cured to form a thermoset composition. In another embodiment of the invention, there is a method of making a biodegradable composition comprising the steps of (a) providing a lignocellulosic reinforcement material; (b) impregnating the lignocellulosic reinforcement material with starch based resin to create an impregnated lignocellulosic reinforcement material; (c) drying the impregnated lignocellulosic reinforcement material; (d) curing the lignocellulosic reinforcement material at a sufficient temperature and a sufficient pressure for a sufficient period of time to produce a thermoset biodegradable composition.

### CROSS-REFERENCE TO RELATED APPLICATIONS

This application claims the benefit of U.S. Provisional Application No. 61/179,252 filed May 18, 2009, which is incorporated herein by reference in its entirety.

### BACKGROUND OF THE INVENTION

1. Field of Invention

This invention relates generally to biodegradable compositions and more specifically to biodegradable starch-based compositions.

2. Discussion of Related Art

Concerns about the environment, both with respect to pollution and sustainability, are rapidly rising. The use of renewable materials from sustainable sources is increasing in a variety of applications. Biopolymers derived from various natural botanical resources such as protein and starch have been regarded as alternative materials to petroleum plastics because they are abundant, renewable and inexpensive. They may be formed through the combination of natural cellulose fibers with other resources such as biopolymers, resins, or binders based on renewable raw materials.

Most commercially available composites used today are made using petroleum based materials. Petroleum-based composites are composed of fibers, such as glass, graphite, aramid, etc., and resins, such as epoxies, polyimides, vinylesters, nylons, polypropylene, etc. Petroleum- or formaldehyde-based resins are inexpensive, colorless, and are able to cure fast to form a rigid polymer. However, the use of petroleum-based composites negatively affects the environment.

Of particular concern is the rate at which petroleum-based composites degrade under the anaerobic conditions present in landfills, potentially persisting without appreciable degradation for decades, if not centuries, rendering the land unusable. In addition, since composites are made using two dissimilar materials, they cannot be easily recycled or reused. This is particularly true for thermoset resins. While the composites may be incinerated to obtain heat value, the toxic gases produced must be treated using expensive scrubbers. Even then, the toxic materials captured by the scrubbers must be further processed. As a result, at the end of their life, most composites end up in land-fills. With applications multiplying in the past few years and expected to increase further, composite waste disposal is a serious concern.

Notwithstanding the environmental impact of disposing of petroleum-based composites, petroleum is not a replenishable commodity and is consumed at an unsustainable rate. As the supply of petroleum dwindles, its price will rise at an ever increasing rate, thereby increasing the price of petroleum-based products.

Biocomposites are materials that can be made from natural or synthetic sources, and include some type of naturally occurring material such as natural fibers in their structure. They may be formed through the combination of natural cellulose fibers with other resources such as biopolymers, resins, or binders based on renewable raw materials.

Extensive research efforts are being directed to develop environment-friendly and fully sustainable “green” polymers, resins and composites that do not use petroleum and wood as the primary feed stocks but are instead based on sustainable sources such as plants. Such plant-based green materials can also be biodegradable and can thus be easily disposed of or composted at the end of their life without harming the environment. Fibers such as kenaf, jute, flax, linen, hemp, bamboo, etc., which have been used for many centuries, are not only sustainable but also annually renewable.

Because of their moderate mechanical properties, efforts are being directed toward the use of fibers in the reinforcement of plastics and the fabrication of composites for various applications. Such fibers may be used alone, as components of yarns, fabrics or non-woven mats, or various combinations thereof. Fully green composites fabricated using plant fibers such as jute, flax, linen, hemp, bamboo, kapok, etc., and resins comprising modified starches or proteins have already been demonstrated and commercialized. High strength liquid crystalline (LC) cellulose fibers, prepared by spinning a solution of cellulose in phosphoric acid, can impart sufficiently high strength and stiffness to composites to make them useful for structural applications. However, since natural fibers are generally weak compared to high strength fibers such as graphite, aramid, etc., composites containing them typically have relatively poor mechanical properties, although they may be comparable to or better than wood. Thus, such composites are suitable for applications that do not require high mechanical performance, for example, packaging, product casings, housing and automotive panels, etc. Nonetheless these applications represent large markets, so increasing use of composites containing biodegradable natural materials should contribute substantially towards reducing petroleum-based plastic/polymer consumption.

Biocomposites can be used for a range of applications, for example: building materials, structural and automotive parts, absorbents, adhesives, bonding agents and degradable polymers. The increasing use of these materials serves to maintain a balance between ecology and economy. The properties of plant fibers can be modified through physical and chemical technologies to improve performance of the final biocomposite.

Recently, efforts have been directed to develop composite materials that use fully-sustainable plant-based materials for both the resins and fibers. Starch is one renewable, biodegradable and inexpensive polymer that is abundant worldwide. It is. found in a wide variety of naturally grown plant products, including rice, maize (e.g., corn), potato, tapioca, and beans.

Recycled paper and recycled paper products are other materials that can be used instead of petroleum and its products. Recycling paper has become a major topic for both consumers and manufacturers alike. Governments, corporations, and organizations all over the world have attempted to recycle paper (and other post-consumer waste). This has led to the production of paper products that are made from waste fiber, as well as a trend towards recycling behaviors within consumer societies. Presently, there are three stages at which to recycle paper: the mill broke stage, the pre-consumer waste stage, and the post consumer waste stage. Therefore there is a continuing need for environmentally-friendly composite materials that do not utilize petroleum and/or petroleum-based products. The present invention addresses one or more of these and other needs.

### SUMMARY OF THE INVENTION

In one aspect, the present invention provides a resin comprising a biodegradable polymeric composition. In some embodiments, the present invention provides a biodegradable polymeric composition comprising a starch polymer. In some embodiments, the present invention provides a composite comprising a starch-based resin, as well as fully sustainable reinforcement materials. Such materials include, for example, recycled paper, postconsumer paper products, and/or paper manufacturing by-products such as mill broke. As described herein, the composite materials comprising a resin comprising a biodegradable polymeric composition exhibit structural properties, including weight, tensile strength, and shear strength, which are suited for many applications, including those mentioned above and herein.

In one aspect of the invention, there is a biodegradable composition comprising lignocellulosic reinforcement material impregnated with a starch based resin and cured to form a thermoset composition.

In another embodiment of the invention, there is a method of making a biodegradable composition comprising the steps of (a) providing a lignocellulosic reinforcement material; (b) impregnating the lignocellulosic reinforcement material with starch based resin to create an impregnated lignocellulosic reinforcement material; (c) drying the impregnated lignocellulosic reinforcement material; (d) curing the lignocellulosic reinforcement material at a sufficient temperature and a sufficient pressure for a sufficient period of time to produce a thermoset biodegradable composition.

In another further comprising a strengthening agent.

In an embodiment, the strengthening agent is selected from the group consisting of nanoclay, microfibrillated cellulose, nanofibrillated cellulose and combinations thereof.

In still another embodiment, the starch based resin is selected from the group consisting of corn starch, wheat starch, tapioca starch, tuber starch rice starch and combinations thereof. Preferably the tuber starch is selected from potato starch, sweet potato starch, yam starch, cassava starch and embodiments thereof.

In one-embodiment, the lignocellulosic reinforcement material comprises fibers of selected from kenaf, jute, flax, linen, hemp and bamboo.

In another embodiment, the lignocellulosic reinforcement material is paper. Generally, the paper is selected from acid-free paper, bleach-free paper, recycled paper, paper by-products, mill broke, newspaper, magazines, fliers, post-consumer waste products, paper towels, napkins, tissues, and paper plates, cardboard, packaging materials, construction paper, recycled paper-containing products, paper bags, stationary, envelopes, corrugated cardboard, office products, printer paper, folders and shredded paper.

In still another embodiment, the lignocellulosic reinforcement material is in the form of a non-woven fabric, yarn, non-woven mats, woven fabric, knitted fabric and randomly oriented fibers.

According to one aspect of the invention, the non-woven mats are selected from needle-punched, wetlaid and air-laid mats comprises reinforcing fibers, reinforcing filaments or reinforcing yarns and/or green reinforcing woven or knitted fabric or non-woven fabric.

In another embodiment, the strengthening agent is a polysaccharide and is selected from the group consisting of agar, gellan gum and mixtures thereof.

In one embodiment, the starch further comprises a plasticizer. The plasticizer of one embodiment further comprises a polyol. The plasticizer comprises glycerol in another embodiment.

The starch based resin of one embodiment comprises a glycol stearate containing starch based resin. Preferrably, the starch based resin is a glycol stearate containing starch based resin selected from the group consisting of glycol stearate containing corn starch, glycol stearate containing wheat starch, glycol stearate containing tapioca starch, glycol stearate containing tuber starch, glycol stearate containing rice starch and combinations thereof.

The plasticizer is selected from carboxyl methyl gum, carboxyl methyl starch and carboxy methyl tamarind according to one aspect of the invention.

In one embodiment, the sufficient temperature to form a composite is about 110° C. to about 140° C. In another embodiment, the sufficient pressure is from about 0.001 tons to about 200 tons per square foot. In yet another embodiment, the sufficient time is a minimum of about 5 min and a maximum of about 120 min.

The present invention is described hereinafter in Detailed Description of the Invention in reference to the drawings and examples, which are intended to teach, describe and exemplify one or more embodiments of the invention and is in no way intended to limit the scope of the invention.

### BRIEF DESCRIPTION OF THE DRAWINGS

FIG. 1 is a bar graph depicting the Mechanical Properties of Paper Products.

FIG. 2 is a line graph depicting the Effect of Phytagel® on the Mechanical Properties of SPI.

FIG. 3 is a bar graph depicting the Mechanical Properties of Composites of Recycled Paper Products with SPI-based Resin.

FIG. 4 is a bar graph depicting the Mechanical Properties of Acceptable Starch Resins with Various Amounts of Sorbitol.

FIG. 5 is a bar graph depicting the Comparison of Mechanical Properties of Composites having Preferred Starch Resins to SPI-based Resin.

FIG. 6 is a bar graph depicting the Mechanical Properties of Starch Resins to SPI-based Resin.

FIG. 7 is a line graph depicting the Effect of Sorbitol on the Mechanical Properties of Starch-based Resin.

FIG. 8 is a bar graph depicting the Comparison of Mechanical Properties of Composites with Starch-based Resins.

FIG. 9 is a bar graph depicting the Comparison of Mechanical Properties of Composites having Starch-based or SPI-based Resins.

FIG. 10 is a schematic diagram showing a technique for fabrication of unidirectional short fiber composites according to the present invention.

FIG. 11a is a schematic diagram showing a warping procedure in preparation for coating/impregnation herein.

FIG. 11b is a schematic diagram showing a sectional warping in preparation for impregnation/coating herein.

FIG. 12 is a schematic diagram showing a resin impregnation technique according to the present invention.

FIGS. 13a and 13b are schematic diagrams showing techniques for drying according to the present invention.

FIG. 14 is a schematic diagram showing a continuous manufacturing process of a composite according to the present invention.

FIG. 15a is a schematic diagram showing a multilayered composite with a hydrophobic sheath according to the present invention.

FIG. 15b is a schematic diagram showing a multilayered composite comprising a fabric based laminate according to the present invention.

FIG. 15c is a schematic diagram showing a multilayered composite comprising laminates and a metal sheath according to the present invention.

### DETAILED DESCRIPTION OF THE INVENTION

In one aspect, the present invention provides a resin comprising a biodegradable polymeric composition. In some embodiments, the present invention provides a biodegradable polymeric composition comprising a starch polymer. In some embodiments, the present invention provides a composite comprising a starch-based resin, as well as fully sustainable reinforcement materials. Such materials include, for example, recycled paper, postconsumer paper products, and/or paper manufacturing by-products such as mill broke. As described herein, the composite materials comprising a resin comprising a biodegradable polymeric composition exhibit structural properties, including weight, tensile strength, and shear strength, which are suited for many applications, including those mentioned above and herein.

### TERMINOLOGY AND DEFINITIONS

The following terms are provided with corresponding definitions which are to be understood in the context of the present application. Any term that is not explicitly defined shall be considered to have a meaning understood by a person of ordinary skill in the art in view of the entire teaching of the specification.

The term “green” is used herein to refer to organic compositions means compositions that are non-toxic; biodegradable organic and renewable. It would be understood that certain inorganic minerals such as “nanoclay” while not biodegradable are non-toxic and benign and can be used without adverse impact to the ecosystem may also be considered, “green.”

The term “biodegradable” is used herein to mean degradable over time by water and/or enzymes found in nature, without harming the environment.

The term “strengthening agent” is used herein to describe a material whose inclusion in the biodegradable polymeric composition of the present invention results in an improvement in any of the characteristics “stress at maximum load”, “fracture stress”, “fracture strain”, “modulus”, and “toughness” measured for a solid article formed by curing of the composition, compared with the corresponding characteristic measured for a cured solid article obtained from a similar composition lacking the strengthening agent.

The term “curing” is used herein to describe subjecting the composition of the present invention to conditions of temperature and pressure effective to form a solid article.

The term “array” is used herein to mean a network structure.

The term “mat” is used herein to mean a collection of raw fibers joined together.

The term “prepreg” is used herein to mean a fiber structure that has been impregnated with a resin prior to curing the composition.

As used herein the measurement “percentage by weight,” “weight percent,” “weight ratio” or similar terms, generally refer to the proportion of weight of a measured component compared to the total weight of all of the ingredients or components of the composition. However, as used in this application to describe a resin composition that can be suspended, mixed or dissolved in a liquid carrier such as water, it is understood that the measurement “percentage by weight,” “weight percent,” “weight ratio” or similar terms refers the proportion of dry weight of a measured component compared to the total dry weight of the composition absent the liquid carrier that is removed or evaporated from the composition in the curing process.

### Starch-Based Resin

In some aspects, the present invention provides a resin comprising a biodegradable polymeric composition. In some embodiments, a resin comprises a starch and a strengthening agent. In some embodiments, such resin is made entirely of biodegradable materials. In some embodiments, a provided resin is made from a renewable source including a yearly renewable source. In some embodiments, no ingredient of the resin is toxic to the human body (i.e., general irritants, toxins or carcinogens). In certain embodiments, a provided resin does not include formaldehyde or urea derived materials.

As described generally above, the present invention provides a resin comprising a starch. Starch is a carbohydrate consisting of a large number of glucose units joined together by glycosidic bonds. This polysaccharide is produced by all green plants as an energy store. Starch is found in a variety of plants such as corn, wheat, tuber plants such as potatoes, rice and cassava. Accordingly, in some embodiments, a starch suitable for use in the present invention is obtained from sources such as corn, wheat, tuber plants, rice and cassava.

When heated in water, starch absorbs water and gelatinizes, losing its semi-crystalline structure. In one embodiment, starch is introduced in the presence of excess water so as to form a three-dimensional matrix of swollen gelatinized starch granules. This thickening activity allows the starch to be used as a resin.

### Glycol Stearate

Glycol Stearate is optionally an ingredient in the starch compositions.

Without wishing to be bound by a particular theory, it is believed that increased crystallinity of the starch imparts a concomitant increase in its mechanical properties. Because gelatinization decreases the crystallinity of starch, additives, such as glycol stearates, to increase the crystallinity and adhesion of starch to other materials. Starch resins are available from Nova Transfers Pvt. Ltd., Mumbai, India. Examples of Glycol stearate containing starch include pre-gelatinized tapioca starch with glycol stearate as plasticizer (“TGS”) available from Noval Transfers Pvt. Ltd under the brand name, “NOVASTAR TGS;” pre-gelatinized maize starch with glycol stearate as plasticizer (“MGS”) available from Noval Transfers Pvt. Ltd. under the brand name, “NOVASTAR MGS;” and pre-gelatinized potato starch with glycol stearate as plasticizer “PGS” available from Noval Transfers Pvt. Ltd. under the brand name, “NOVASTAR PGS.”

The properties of the starch based resins can be further modified by a variety of additives, as described herein.

### Strengthening Agents

In another embodiment, the present invention provides a resin comprising a starch and one or more strengthening agents. In some embodiments, the strengthening agent is a cross-linking agent. In one embodiment, the strengthening agent is a green polysaccharide. In another embodiment, the strengthening agent is a carboxylic acid. In yet another embodiment, the strengthening agent is nanoclay. In yet another embodiment, the strengthening agent is a microfibrillated cellulose or nanofibrillated cellulose. In some embodiments, the weight ratio of starch to first strengthening agent in the biodegradable polymeric composition of the present invention is about 20:1 to about 1:1.

Green Polysaccharides. In some embodiments, the first strengthening agent is a green polysaccharide. In some embodiments, the green polysaccharide is agar, gellan, gellan gum (Phytagel™), carageenan or a mixture thereof.

Gellan gum is commercially available as from Sigma-Aldrich Biotechnology. It is produced by bacterial fermentation and is composed of glucuronic acid, rhanmose and glucose, and is commonly used as a gelling agent for electrophoresis. Based on its chemistry, cured Phytagel™ is fully degradable. Gellan, a linear tetrasaccharide that contains glucuronic acid, glucose and rhamnose units, is known to form gels through ionic crosslinks at its glucuronic acid sites using divalent cations naturally present in most plant tissue and culture media. In the absence of divalent cations, higher concentration of gellan is also known to form strong gels via hydrogen bonding.

Nanoclay. In some embodiments, the first strengthening agent is clay. In other embodiments, the clay is nanoclay. In some embodiments, nanoclay has a dry particle size of 90% less than 15 microns. The composition can be characterized as green since the nanoclay particles are natural and simply become soil particles if disposed of or composted. Without being limited to a particular theory, it is believed that nanoclay does not take part in the crosslinking but is rather present as a reinforcing additive and filler. As used herein, the term “nanoclay” means clay having nanometer thickness silicate platelets. In some embodiments, nanoclay is natural clay such as montmorillonite. In other embodiments, nanoclay is selected from the group comprising fluorohectorite, laponite, bentonite, beidellite, hectorite, saponite, nontronite, sauconite, vermiculite, ledikite, nagadiite, kenyaite and stevensite.

Cellulose. In some embodiments, the first strengthening agent is cellulose. In some embodiments, cellulose is a microfibrillated cellulose (MFC) or nanofibrillated cellulose (NFC). MFC is manufactured by separating (shearing) the cellulose fibrils from several different plant varieties. Further purification and shearing, produces nanofibrillated cellulose. The only difference between MFC and NFC is size (micrometer versus nanometer). The compositions are green because the MFC and NFC degrade in compost medium and in moist environments through microbial activity. Up to 60% MFC or NFC by weight (starch plus green strengthening agent basis) improves the mechanical properties of the composition significantly. The MFC and NFC do not take part in any crosslinking but rather are present as strengthening additives or filler. However they are essentially uniformly dispersed in the biodegradable composition and, because of their size and aspect ratio, act as reinforcement.

It will be appreciated by those skilled in the art that a resin of the present invention also includes resins containing various combinations of strengthening agents. For example only, in one embodiment the resin composition comprises a starch from 98% to 20% by weight starch (starch plus first strengthening agent basis) and from 2% to 80% by weight of first strengthening agent (starch plus first strengthening agent basis) wherein the first strengthening agent consists of from 1% to 65% by weight cured green polysaccharide and from 0.1% to 15% by weight nanoclay (starch plus nanoclay plus polysaccharide basis).

In another embodiment, the resin composition comprises a starch from 98% to 20% by weight starch (starch plus first strengthening agent basis) and from 2% to 80% by weight of first strengthening agent (starch plus first strengthening agent basis) wherein the first strengthening agent consists of from 1% to 79% by weight cured green polysaccharide and from 0.1% to 79% by weight microfibrillated or nanofibrillated cellulose (starch plus polysaccharide plus MFC or NFC basis).

### Plasticizer

In addition to a first strengthening agent, a provided resin may include one or more additives. In some embodiments, such additives include a plasticizer. Accordingly, a provided resin comprising a starch and a first strengthening agent optionally further comprises a plasticizer. Without wishing to be bound by any particular theory, it is believed that the addition of a plasticizer increases the strength and rigidity of the composite by reducing the brittleness of the cross-linked starch. In some embodiments, the weight ratio of plasticizer:(starch+first strengthening agent) is about 1:20 to about 1:4. In some embodiments, the ratio of starch to plasticizer is 4:1. Suitable plasticizers for use in the present invention include a hydrophilic or hydrophobic polyol. In some embodiments, a provided polyol is a C₁₋₃ polyol. In one embodiment, the C₁₋₃ polyol is glycerol. In other embodiments, a provided polyol is a C₄₋₇ polyol. In one embodiment, the polyol is a C₆ polyol—eg, sorbitol.

In still other embodiments, a plasticizer is selected from the group comprising carboxyl methyl gum, carboxyl methyl starch and carboxy methyl tamarind or a combination thereof.

### Exemplary Composite Fabrication

As described above, composite materials made in accordance with the present invention include resins comprising starches, in combination to varying extents with other additives such as, for example, glycerol, sorbitol, carboxyl methyl gum, carboxyl methyl starch, carboxy methyl tamrind, and any combinations thereof.

The starch (pre-gelatinized) resins may be pre-cured by magnetically stirring starch, water and optionally one or more additives.

### Reinforcement Materials

Exemplary materials for use as the reinforcement material include, but are not limited to, natural cellulose fibers, cellulose fibers, yams, woven and knitted fabrics, nonwoven mats, papers (e.g., acid-free papers, bleach-free paper), paper products such as recycled paper, and paper by-products such as mill broke, among many others. In some embodiments, paper suitable for use in the present invention includes newspaper, magazines, fliers, post-consumer waste products such as paper towels, napkins, tissues, and paper plates, etc., cardboard and other packaging materials, construction paper, recycled paper-containing products, paper bags, stationary, envelopes, corrugated cardboard, office products such as printer paper and folders, and shredded paper. In some embodiments, paper products suitable for use in the present invention include materials having a porosity that permits a sufficient amount of starch-based resin to permeate the reinforcement materials. Other materials that are used for the reinforcement materials may be selected based on other physical properties, such as, for example, shear strength, tensile strength, molecular weight, density, as well as other properties that may provide for, and/or enhance other properties of the resultant composite materials.

In some embodiments, a reinforcement material such as a paper product is impregnated, or otherwise contacted, with a provided resin. Thus, in one embodiment, the present invention provides a method of impregnating a paper product with a provided resin. In some embodiments, the resultant resin-impregnated paper is dried to form a prepreg. In some embodiments, the resin-impregnated paper is air dried. In some embodiments, the resin-impregnated paper is oven dried. In some embodiments, the resin-impregnated paper is vacuum dried. In some embodiments, the prepreg is optionally reimpregnated with additional resin and dried. This process is optionally repeated until the desired resin composition relative to the reinforcement material of the prepreg is reached. One or more prepregs may be stacked together and then cured to form a composite. One or more prepregs may be stacked together and then cured to form a composite. Optionally, a plurality of sheets of paper can be impregnated and dried to form prepregs and stacked together and cured into a composite. In some embodiments, the composite is formed by pressing one or more prepregs. In some embodiments, pressure sufficient to form a composite is about 0.001 tons to about 200 tons per square foot. In some embodiments, the composite is formed by heating one or more prepregs to a temperature sufficient to form a thermoset composition. In some embodiments, temperature sufficient to form a thermoset composite is about 110° C. to about 140° C. In some embodiments, the prepreg is cured by subjecting the prepreg to conditions of both heating and pressure.

In other embodiments, the composites are fabricated using fibers in a variety of forms including non-woven mats (non-woven mats include needle-punched, wetlaid, air-laid, etc.), woven and knitted fabrics, and randomly oriented fibers. In some embodiments, provided composites include hybrid composites, which may be formed by using combinations of fibrous materials and papers. In some embodiments, provided composites are fabricated by organizing a layered structure to obtain the desired mechanical properties such as tensile strength and stiffness, and bending strength and stiffness. In some embodiments, the layered composites or hybrid composites are hot pressed into a desired shape. In some embodiments, provided composites are processed into a variety of corrugated shapes to be incorporated or sandwiched between two flat composite sheets to form light weight composites. In some embodiments, the corrugated sheets may be placed in one direction to obtain stiffness of the composite in the direction of the corrugation. In other embodiments, two corrugated sheets may be placed at right angles to each other (and on top of each other) to obtain stiffness of the composite in both directions. In some embodiments, the paper sheets can also be processed into hexagonal sheets for sandwiching between two flat composite sheets (similar to corrugated sheets) to form light weight composites. The strength, toughness and other mechanical properties of such composites will depend on the individual component properties.

In still other embodiments, the composite materials are formed from shredded paper that may be coated by spraying with a provided resin. In some embodiments, the resin-impregnated shredded paper is put into a mold and hot pressed to produce composite sheets or molded to desirable shapes. In some embodiments, the paper is first shredded into strips or small pieces using commercial shredder, coated with a provided resin, and dried, before being hot pressed to produce a flat or molded composite. In some embodiments, the paper is impregnated with resin and dried to form a prepreg, which is shredded before being subjected to conditions sufficient to form a composite.

In yet other embodiments, the composite materials are engineered using layered structures in various thicknesses to obtain desired mechanical properties depending on the applications.

### EXAMPLES

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

While the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

### Materials

Materials for Resin Preparation. Soy Protein Isolate (SPI) powder, PRO-FAM® 974, was obtained from Archer Daniels Midland Co., Decatur, Ill. Analytical grade glycerol was purchased from Fisher Scientific, Pittsburgh, Pa. Phytagel® was purchased from Sigma-Aldrich Co., St. Louis, Mo. Starches for use in the present invention include Novastar-TG (pre-gelatinized tapioca starch with galacto mannen), Novastar-MG (pre-gelatinized maize starch with galacto mannen), Novastar-PG (pre-gelatinized potato starch with galacto mannen), Novastar-TGS (pre-gelatinized tapioca starch with glycol stearate as plasticizer), Novastar-MGS (pre-gelatinized maize starch with glycol stearate as plasticizer) and Novastar-PGS (pre-gelatinized potato starch with glycol stearate as plasticizer). These starches were supplied by Nova Transfers Pvt. Ltd., Mumbai, India. Sorbitol was purchased from Sigma-Aldrich Co., St. Louis, Mo. CMG (Carboxyl Methyl Gum), CMS (Carboxyl Methyl Starch) and CMT (Carboxyl Methyl Tamarind) were supplied by Nova Transfers Pvt. Ltd., Mumbai, India.

Paper Products. Bounty® paper towels were purchased from Proctor & Gamble, Cincinnati, Ohio. Georgia-Pacific Acclaim® paper towels and Georgia-Pacific enMotion® paper towels were purchased from Georgia-Pacific, Atlanta, Ga. Kleenex® Scottguard paper towels were purchased from Kimberly-Clark Corporation, Neenah, Wis. Cornell Daily Sun newspaper was collected from the Cornell University campus, Ithaca, N.Y.

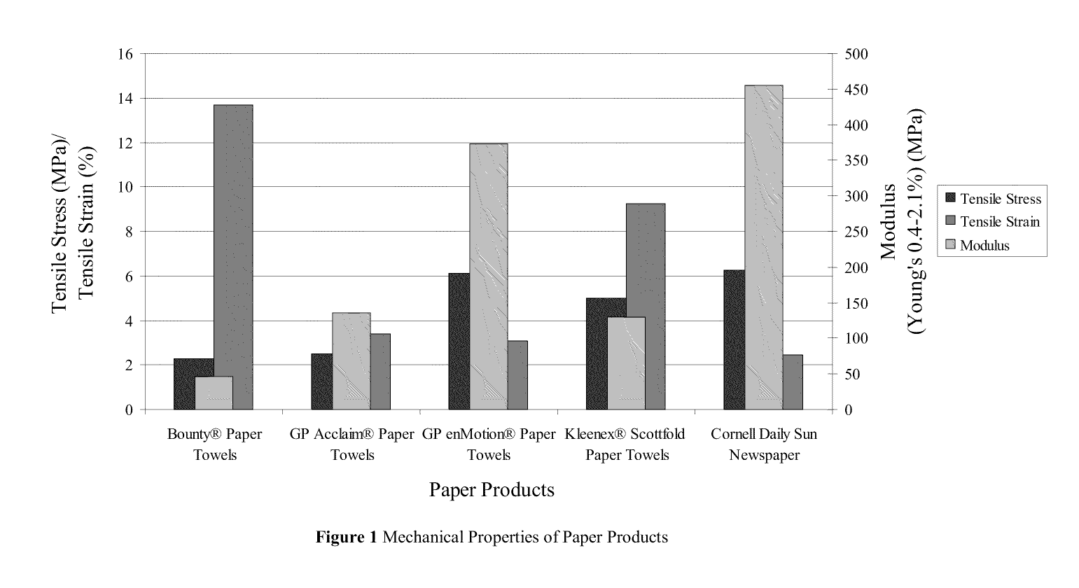

Prior to being impregnated by the SPI resin, the mechanical properties of the paper products were tested using the Instron machine (model 55-66, Instron Co., Canton, Mass.) as described herein. These results can be found in Table 1, where the mean result is given with the standard deviation in italics. Additionally, a graph comparing these mechanical properties can be found in FIG. 1. The paper products were conditioned at 21° C. and 65% relative humidity (RH) for three days prior to testing.

TABLE 1
Tensile Stress and Tensile Strain of Non-Impregnated Paper Products

| | Tensile | Tensile | Modulus |
|---|---|---|---|
| | Stress at | Strain at | (Young's |
| | Max Load | Max Load | 0.4-2.1%) |
| | (MPa) | (%) | (MPa) |
| Bounty ® Paper | 2.28 | 13.67 | 46.68 |
| Towels | (0.32) | (2.32) | (10.84) |
| GP Acclaim ® Paper | 2.50 | 3.38 | 135.33 |
| Towels | (0.38) | (1.03) | (20.64) |
| GP enMotion ® Paper | 6.13 | 3.08 | 372.99 |
| Towels | (0.90) | (0.45) | (66.20) |
| Kleenex ® Scottfold | 5.01 | 9.24 | 130.05 |
| Paper Towels | (0.58) | (1.04) | (12.15) |
| Cornell Daily Sun | 6.25 | 2.44 | 455.68 |
| Newspaper | (1.22) | (0.90) | (52.38) |

### Manufacturing Process

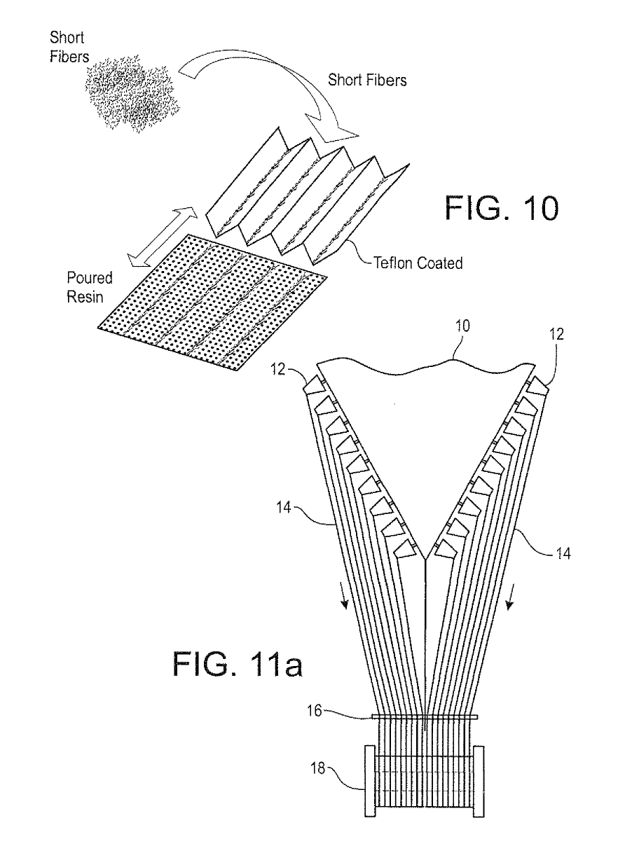

As shown in FIG. 10, short fibers are dispensed onto pleats of a pleated Teflon® coated cardboard or plastic or metal sheet material substrate plate to form rows of aligned unidirectional short fibers, with one row in each pleat. The fibers in each pleat are fed as rows of unidirectional fibers on a sheet of resin mixture in water. The sheet of resin with rows of unidirectional fibers thereon/therein is precured and then cured by hot pressing at a sufficient temperature and a sufficient pressure for a sufficient period of time to form a thermoset composition.

Parallel arrays of yarns constituted of flax material or other yarns or filaments or individual sections of such parallel arrays are impregnated with starch resins of one or more of the embodiment of the invention.

FIG. 11a depicts warping procedure for preparing a single parallel array. As shown in FIG. 11a, apparatus and process for preparing a single array comprise, a creel 10 supporting individual yarn packages or bobbins 12 for feeding yarns 14 over a guide 16 to a warping beam 18 where the yarns are then collected in parallel array.

As shown in FIG. 11b, apparatus and process for preparing sections of parallel array yarns comprise a creel 20 supporting individual yarn packages 22, feeding yarns 24, over a comb 26 to form sections of parallel array yarns 28 on sectional beam 30 .

The impregnation herein is carried out on the parallel yarn arrays downstream of the guide 16 or comb 26 and upstream of beams 18 and 29 .

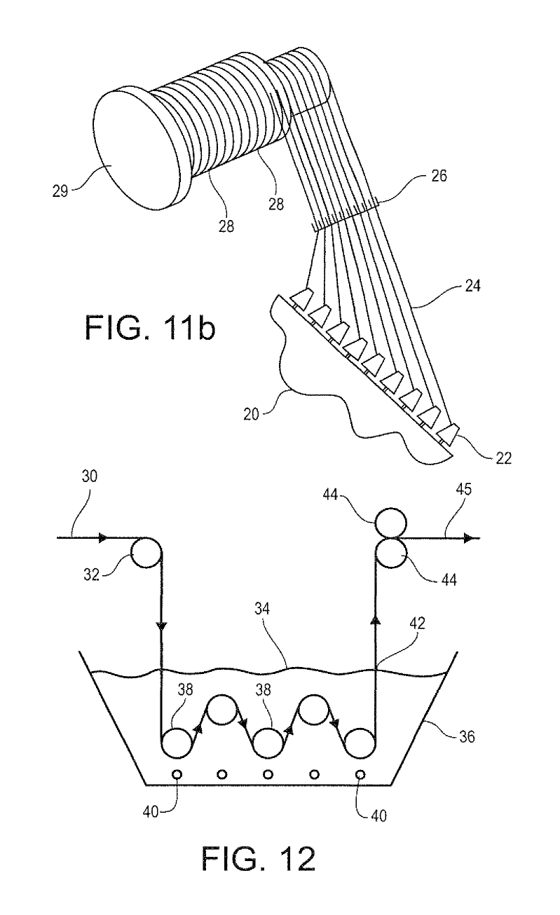

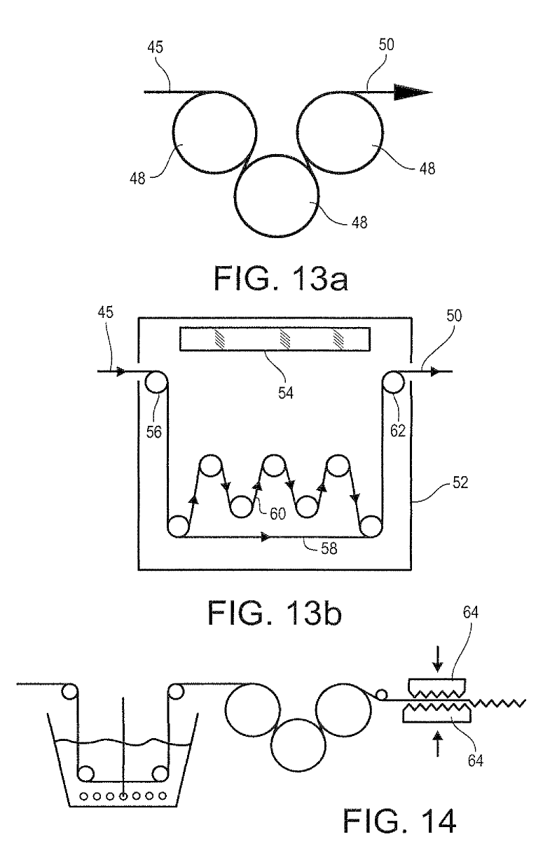

FIG. 12 depicts resin impregnation according to the invention on the yarn parallel arrays. As shown in FIG. 12, parallel arrays 30 (alternately *oven or non-woven fabric) are fed over a guide roller 32 into a bath 34 of precuring starch based resin in a container 36 (eg., resin bath). The resin bath 36 contains an admixture of starch-based resin according to one or more embodiments of the present invention. The parallel arrays 30 pass through bath 34 via immersion rollers 38. The impregnating apparatus constituted of container 36 holding bath 34 contains below the level of the bath 34 heating elements 40 to provide precured resin toward the outlet side. The parallel arrays are coated/impregnated in bath 34 with precured resin bath and leave the bath as parallel arrays coated with precured resin at 42 and then are passed through the nip of squeeze rolls 44 to remove excess precured resin whereupon the coated/impregnated parallel arrays 45 are then passed to drying, with method/apparatus for this schematically depicted in FIGS. 13a and 13b. FIG. 13a depicts drying cylinders 48 in series and entering coated parallel array is shown at 45 and exiting dried coated parallel array is shown at 50. FIG. 13b schematically depicts an alternative method and apparatus for drying. As shown in FIG. 13b, a drier contains a microwave or infrared source 54 and parallel array coated with precured resin passes over guide roller 56 and via path 58 or path 60 (for more residence time), leaving via exit guide roller 62 as dried coated parallel array as shown at 50. The dried precured resin coated parallel arrays are then subjected to resin curing treatment. FIG. 14 shows the dip coating process/apparatus of FIG. 12, followed by the drying process/apparatus of FIG. 13a, followed by curing. The curing is carried out by hot pressing dies 64 .

Parallel arrays of green fibers, or green filaments, or green fabric (woven, knitted or non-woven) can be substituted for the parallel arrays of yarn above, to produce composites with cured coating coated thereon and/or impregnated therein.

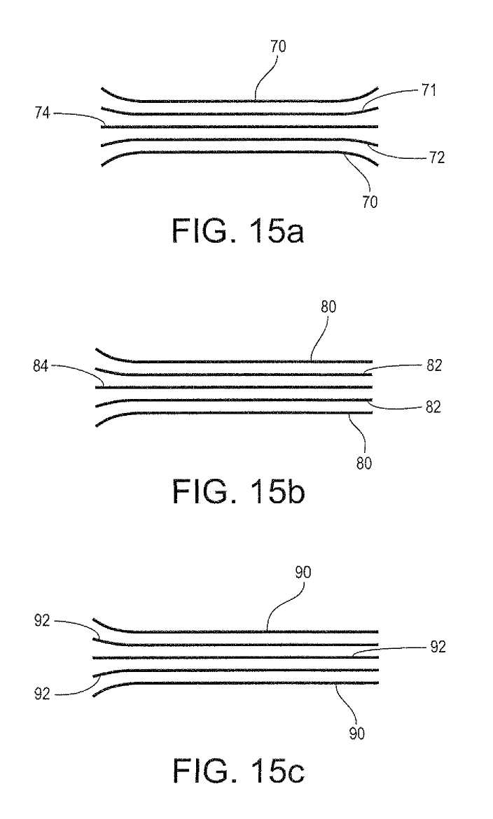

FIG. 15a shows a multilayered green composite with polylactic acid/polyhydroxybutyrate sheath layers 70 as outside layers of a composite with interior mat based laminates 72 and a central yarn based laminate 74. The layer 72 and 74 are coated impregnated with resin according to one or more embodiments of the invention. The curing (e.g., hot pressing) can be carried out after the layers are stacked.

FIG. 15b shows a multilayered green composite with outer fabric base laminates 80, inner non-woven mat composite based laminates 82 adjacent inner side of each layer 80 and a central fiber based laminate 84 where all of the layers contain resin herein. The resin may be cured in a stack of all the layers at once.

FIG. 15c depicts a hybrid metal layer green layer composite containing outer metal sheath layers 90 and green resin laminates 92 of the invention herein. The metal sheath protects the green layers from water. The composite can be used in applications at low temperature where metals are currently used. The green portion reduces the total weight compared to all metal corresponding items. At the end of the functional life of the composite, the metal sheath can be peeled and the metal recycled and the green portion can be degraded.

In examples the term resin is used to mean biodegradable composition herein prior to curing and cured resin refers to the same after curing.

The foregoing description of the invention has been presented describing certain operable and preferred embodiments. It is not intended that the invention should be so limited since variations and modifications thereof will be obvious to those skilled in the art, all of which are within the spirit and scope of the invention.

### Resin and Composite Preparation

### Example 1

### Resin Preparation of Soy Protein Isolate (SPI) Resin Sheet

SPI resin was characterized by preparing a resin sheet in a Teflon®-coated mold created from a Teflon® sheet. A square sheet of Teflon® was cut to the desired size and attached to a glass plate. One inch on each side was folded inwards to create the walls of the Teflon® mold, forming a box in which the resin formed. First, the SPI resin was prepared in a process called “pre-curing”. The desired amount of SPI powder was added to a glass beaker. 20% (of the total SPI weight) of glycerol was added to this beaker. 15 times by weight (15 mL per gram of SPI) of distilled water was then added to this mixture. The mixture was magnetically stirred at room temperature for 30 minutes to form a uniform dispersion. After 30 minutes, the mixture was transferred to a water bath at 80° C. and stirred for an additional 30 minutes.

This pre-cured solution was poured into the Teflon® mold and placed in an oven at 50° C. to dry overnight. The following day, the dried resin film was removed from the Teflon® mold and placed into a conditioning room maintained at the ASTM D 1776-98 conditions of 21° C. and 65% relative humidity (RH) for approximately two hours. The resin was then placed between two aluminum plates and “cured” (cross-linked) by hot pressing at 120° C. under 38,300 lbs of pressure for 15 minutes. The hot-pressing was performed using a Carver Hydraulic hot press (model 3891-4PROA00, Carver Inc., Wabash, Ind.). Following the curing process, the resin was kept in the conditioning room for three days.

### Example 2

### Modification of SPI Resins

SPI resin was modified using Phytagel® to improve the mechanical properties of the SPI. During the pre-curing process, the desired percentage (of the total SPI weight) of Phytagel® powder was placed into a separate glass beaker. 50 times by weight (50 mL per gram of Phytagel®) of distilled water was added to this beaker. This solution was stirred by hand using an aluminum stirrer in order to break down the gel clumps that form when Phytagel® powder is mixed with water. Once stirred by hand, this solution was added to the SPI solution and pre-cured as described with the SPI resin.

### Example 3

### Preparation of Resin and Starch Resin Sheet

The preparation of the starch resin was consistent for all six starches (TG, MG, PG, TGS, MGS and PGS) used throughout this experiment. The desired amount of starch powder was added to a glass beaker. The desired amount of sorbitol was added to the starch, based on the percentage of starch weight desired. This powder mixture was stirred by hand using an aluminum stirrer in order to evenly disperse the powders before adding liquid. 50 times by weight (50 mL per gram of starch) of distilled water was added to this beaker. The mixture was magnetically stirred at room temperature for 30 minutes. After 30 minutes, the mixture was then transferred to a water bath at 80° C. and stirred for an additional 30 minutes.

This pre-cured solution was poured into a Teflon® mold and placed in an oven at 45° C. to dry overnight. The following day, the dried resin film was removed from the Teflon® mold and placed into a conditioning room at 21° C. and 65% relative humidity (RH) for approximately 30 minutes. The resin was then cured by hot pressing at 110° C. under 38,300 lbs of pressure for 15 minutes. Following the curing process, the resin was kept in the conditioning room for three days.

### Example 4

### Modification of Starch Resins

The MG and MGS starch resins were modified by adjusting the plasticizer content in order to improve the mechanical properties of the resin. First, the addition of sorbitol to the starch solution was eliminated and replaced by the CMG, CMS and CMT thickeners. The desired amount of thickener was added to the starch powder, based on the percentage of starch weight desired. The starch powder and plasticizer powder were then stirred by hand in order to evenly disperse the powders. Once stirred by hand, the preparation process was carried out as described with the starch resin.

Following this modification, the MGS starch resin with 30% by weight of CMG was modified in order to increase the tensile strain of the resin. Sorbitol was added as a plasticizer to this mixture in the powder form. All three powders were combined and stirred by hand to promote an even mixture. The amount of sorbitol added was based on the percentage of starch weight desired. Once stirred, the film preparation process was carried out as described with the starch resin.

### Example 5

### Composite Fabrication

Composites were fabricated using recycled paper products and modified starch resin. Composites were fabricated using Georgia-Pacific Acclaim® paper towels, Georgia-Pacific enMotion® paper towels and Cornell Daily Sun newspaper with the addition of MGS+30% CMG+5% sorbitol (by weight) resin as well as MGS+30% CMG+10% sorbitol (by weight) resin, creating a total of six different composite recipes. A square was cut out of the paper product and weighed. The size of the square, as well as the amount of squares cut out, were determined based on the desired amount. The precured starch resin was then poured onto the individual sheets of paper product and the sheets were impregnated with resin by hand. The sheets were then placed into an oven to dry at 65° C. Once dry, the paper was weighed to determine the composition of resin. This process was repeated until the composition of the resin was 40-50% of the total composite weight.

Once dry, the impregnated paper product sheets were placed into the conditioning room at 21° C. and 65% RH overnight. The following day, stacked multiple sheets of impregnated paper were hot-pressed at 120° C. under 38,300 lbs of pressure for 25 minutes, thereby forming a composite. The aluminum plates were either flat or corrugated, depending on the shape desired of the composite. After being hot pressed, the samples were returned to the conditioning room for three days.

### Example 6

### Recycled Paper Products with SPI and Phytagel® Resin

Composites were fabricated using recycled paper products and SPI with Phytagel® resin. To prepare the composite specimens, a square was cut out of the paper product and weighed. The size of the square, as well as the amount of squares cut out, were determined based on the desired amount. The pre-cured SPI with 30% Phytagel® (by weight) resin was poured onto each sheet of paper separately. The resin was impregnated into the paper by hand by pasting the resin on both sides of the paper sheet. The sheets were then placed into an oven to dry at 65° C. Once dry, the paper was weighed to determine the composition of resin. The process of impregnating the sheet of paper with SPI/30% Phytagel® pre-cured resin was repeated until the desired composition of resin (by weight) was reached.

Once the paper sheets were dry, they were placed into the conditioning room at 21° C. and 65% RH for 30 minutes. A single sheet of the impregnated paper was cured by hot-pressing, followed by stacked multiple sheets of impregnated paper, at 120° C. under 38,300 lbs of pressure for 25 minutes. From hot-pressing the multiple sheets together, a composite was formed. The aluminum plates were either flat or corrugated, depending on the shape desired of the composite. After being hot pressed, the samples were returned to the conditioning room for three days.

### Example 7

### Recycled Paper Products with Starch Resin

Composites were fabricated using Georgia-Pacific Acclaim® paper towels, Georgia-Pacific enMotion® paper towels and Cornell Daily Sun newspaper with the addition of MGS+30% CMG+5% sorbitol (by weight) resin as well as MGS+30% CMG+10% sorbitol (by weight) resin, creating a total of six different composite recipes. A square was cut out of the paper product and weighed. The size of the square, as well as the amount of squares cut out, were determined based on the desired amount. The precured starch resin was then poured onto the individual sheets of paper product and the sheets were impregnated with resin by hand. The sheets were then placed into an oven to dry at 65° C. Once dry, the paper was weighed to determine the composition of resin. This process was repeated until the composition of the resin was 40-50% of the total composite weight.

Once dry, the impregnated paper product sheets were placed into the conditioning room at 21° C. and 65% RH overnight. The following day, the curing process was carried out as described by the recycled paper products with SPI/30% Phytagel®.

### Characterization Techniques—Tensile Testing and Measurement of Moisture Content

The tensile properties of the resins, composites and paper products were determined according to ASTM D 882-02 procedure. All specimens were cut into 1 cm wide×5 cm long strips after being conditioned for three days at 21° C. and 65% relative humidity prior to testing. The tensile test was performed using an Instron universal testing machine (model 55-66, Instron Co., Canton, Mass.), where the tensile properties were calculated by the machine. The parameters used by the Instron can be found in Table 2:

TABLE 2
Instron Parameters for Tensile Testing

| | |
|---|---|
| Load Cell | 10 kN |
| Strain Rate | 100%/min |
| Gauge Length | 5 cm |
| Specimen Width | 1 cm |

The moisture content of the resins, composites and paper products were determined according to the ASTM D 1576-90 procedure. The test was carried out using a moister/volatiles tester (model-SAS, C.W. Brabender Instruments, Inc., South Hackensack, N.J.). Following the conditioning at 21° C. and 65% RH and the tensile tests, the specimen strips were weighed and then kept in the machine at 105° C. 24 hours later the specimens were weighed and the moisture content was determined using the following equation:

$$Moisture Content = ( \frac{A - B}{A} ) \times 100$$

where A=weight of original specimens and B=weight of the specimens after 24 hours of drying at 105° C.

### Example 8

### Soy Protein Isolate Modified with Phytagel®

First strengthening agent Phytagel® was added to Soy Protein Isolate to improve the mechanical properties. Additionally, glycerol was used as the plasticizer (20% glycerol by weight of SPI was used for all samples). Resin films were prepared using the addition of 10%, 20% and 30% Phytagel® (by weight of SPI) in the SPI resin. The recipes used for these films were: a) the SPI-based solution: 10 g SPI+2 g (20%) glycerol+150 mL (15×) distilled H₂O and b) the Phytagel® solution: 1.0 g, 2.0 g, or 3.0 g (10%, 20%, or 30%, respectively)+50 mL, 100 mL, or 150 mL (50× the weight of Phytagel® used, respectively). These two solutions were stirred separately and then combined into one solution. The results of these resins, as compared to SPI alone, can be found in Table 3, where the mean result is given and the italics in parenthesis represent the standard deviations.

TABLE 3
Tensile Properties of Resins Comprised of Varying Amounts
of Phytagel ®

| | Tensile | Tensile | Modulus |
|---|---|---|---|
| | Stress at | Strain at | (Young's |
| | Max Load | Max Load | 0.4-2.1%) |
| | (MPa) | (%) | (MPa) |
| SPI + 0% Phytagel ® | 6.33 | 147.94 | 175.28 |
| (Control) | (0.70) | (25.0) | (15.79) |
| SPI + 10% Phytagel ® | 13.01 | 26.62 | 367.95 |
| | (1.22) | (5.18) | (17.85) |
| SPI + 20% Phytagel ® | 17.23 | 28.70 | 459.45 |
| | (1.60) | (7.28) | (34.35) |
| SPI + 30% Phytagel ® | 20.29 | 19.42 | 552.08 |
| | (2.49) | (3.25) | (60.37) |

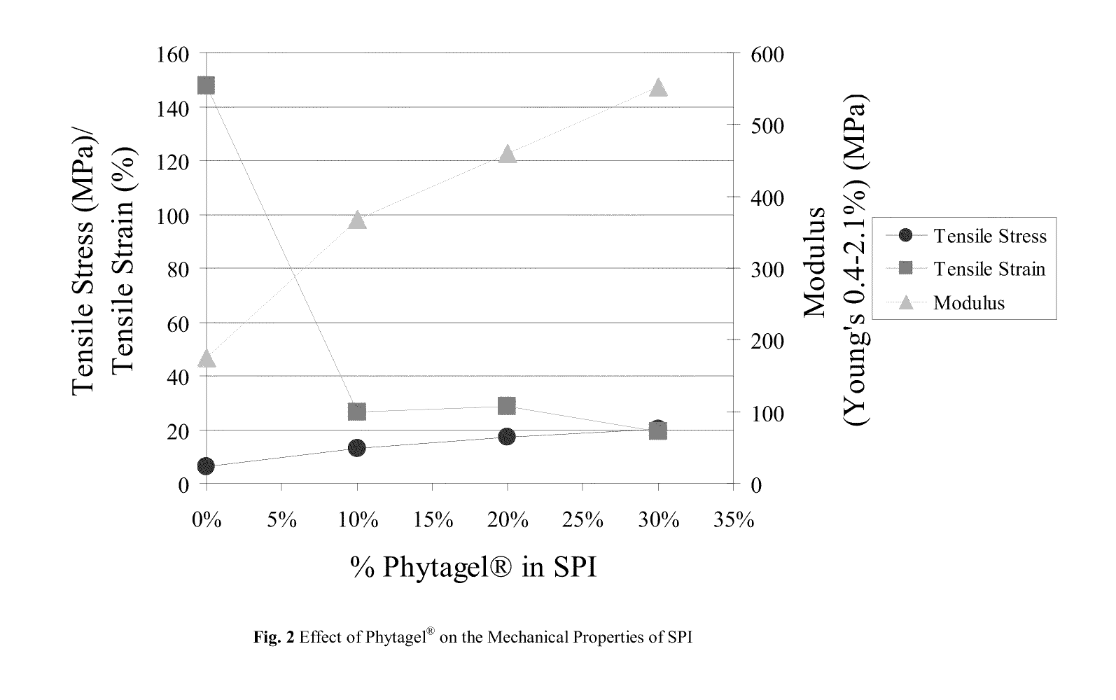

The addition of Phytagel® had a beneficial effect on the SPI resin. The control (MPa) sample, SPI with 0% Phytagel®, shows a low tensile stress and low modulus with a high tensile strain. The desired properties for a composite resin should have a higher stress and a higher modulus with a much lower strain. These properties were improved with increasing amounts of Phytagel®. The best mechanical properties were obtained from SPI+30% Phytagel®, due to having the highest tensile stress (20.29 MPa), the highest Modulus (552.08 MPa), and the lowest tensile strain (19.42%), as depicted in FIG. 2. Although an increase in tensile strain is often desired to increase the ductility, the tensile strain found in SPI+30% Phytagel® is enough to prevent the resin from having brittle characteristics. In fact, the tensile strain can be decreased because this strain shows that the resin must deform a significant amount prior to fracture. In the desired applications, a lower strain is necessary so that the resin does not greatly deform under stress.

Recycled Paper Product Composites with SPI Resin

Various paper products were fabricated into composites using SPI Resin+30% Phytagel®. The paper products used were porous to absorb the resin and did not already contain a resin film, which can be seen on glossy paper products such as magazines. Paper products were collected from around Cornell University's campus facilities (including dining halls and bathrooms) as well as bought from grocery stores and craft stores.

The recycled paper products having a high strength and porous structure, such as paper towels and newspaper, were used to make composites. Such paper products include Bounty® paper towels, Georgia-Pacific (GP) Acclaim® paper towels, Georgia-Pacific (GP) enMotion® paper towels, Kleenex Scottfold paper towels, and the Cornell Daily Sun newspaper, as described infra.

### Example 9

### Bounty® Paper Towel and SPI Composite

Bounty® paper towels were found to absorb a large amount of SPI resin within a small number of impregnations. After two impregnations, the composition of the impregnated sheets were 60% SPI resin and 40% Bounty® paper towel (by weight). A single sheet was cured by hot-pressing, as well as 14 sheets cured together, forming a composite. The mechanical properties of the Bounty® paper towel and SPI composite, as compared to the dry Bounty paper towel (no resin) and the SPI+30% Phytagel® resin film can be found in Table 4.

TABLE 4
Tensile Properties of Bounty ® Paper Towel SPI Composite

| | Tensile | Tensile | Modulus |
|---|---|---|---|
| | Stress at | Strain | (Young's |
| | Max Load | at Max Load | 0.4-2.1%) |
| | (MPa) | (%) | (MPa) |
| SPI + 30% Phytagel ® | 20.29 | 19.42 | 552.08 |
| Resin Film | (2.49) | (3.25) | (60.37) |
| Bounty ® Paper Towels | 2.28 | 13.67 | 46.68 |
| | (0.32) | (2.32) | (10.84) |
| Bounty ® Paper Towel with 60% | 17.30 | 13.41 | 535.41 |
| SPI Resin - 1 Sheet | (2.24) | (1.71) | (79.61) |
| Bounty ® Paper Towel with 60% | 30.16 | 25.85 | 781.94 |
| SPI Resin - 14 Sheets | (1.41) | (1.59) | (66.36) |

### Example 10

### Georgia-Pacific Acclaim® Paper Towel and SPI Composite

The GP Acclaim® paper towels reached a composition of 55% SPI resin and 45% paper towel after three impregnations. Although this was an additional impregnation as compared to the highly absorbent Bounty® paper towels, it still was found to be an absorbent paper product. A single sheet was cured, as well as 14 stacked sheets cured together, forming a composite. The mechanical properties of the GP Acclaim® paper towel and SPI composite, as compared to the dry GP Acclaim® paper towel (no resin) and the SPI+30% Phytagel® resin film can be found in Table 5.

TABLE 5
Tensile Properties of GP Acclaim ® Paper Towel SPI Composite

| | Tensile | Tensile | Modulus |
|---|---|---|---|
| | Stress at | Strain | (Young's |
| | Max Load | at Max Load | 0.4-2.1%) |
| | (MPa) | (%) | (MPa) |
| SPI + 30% Phytagel ® Resin Film | 20.29 | 19.42 | 552.08 |
| | (2.49) | (3.25) | (60.37) |
| GP Acclaim ® Paper Towels (No | 2.50 | 3.38 | 135.33 |
| Resin) | (0.38) | (1.03) | (20.64) |
| GP Acclaim ® Paper Towels with | 24.86 | 11.43 | 881.15 |
| 55% SPI Resin - 1 Sheet | (2.62) | (0.68) | (87.44) |
| GP Acclaim ® Paper Towels with | 35.10 | 17.44 | 1183.50 |
| 55% SPI Resin - 14 Sheets | (2.53) | (1.65) | (113.04) |

### Example 11

### Georgia-Pacific enMotion® Paper Towel and SPI Composite

The GP enMotion® paper towels were also found to be absorbent, as they reached a composition of 57% SPI resin and 43% paper towel after three impregnations. A single sheet was cured, as well as 11 sheets cured together, forming a composite. The mechanical properties of the GP enMotion® paper towel and SPI composite, as compared to the dry GP enMotion® paper towel (no resin) and the SPI+30% Phytagel® resin film can be found in Table 6.

TABLE 6
Tensile Properties of GP enMotion ® Paper Towel SPI Composite

| | Tensile | Tensile | Modulus |
|---|---|---|---|
| | Stress at | Strain | (Young's |
| | Max Load | at Max Load | 0.4-2.1%) |
| | (MPa) | (%) | (MPa) |
| SPI + 30% Phytagel ® Resin Film | 20.29 | 19.42 | 552.08 |
| | (2.49) | (3.25) | (60.37) |
| GP enMotion ® Paper Towels | 6.13 | 3.08 | 372.99 |
| (No Resin) | (0.90) | (0.45) | (66.20) |
| GP enMotion ® Paper Towels | 16.51 | 7.58 | 824.01 |
| with 55% SPI Resin - 1 Sheet | (2.44) | (1.63) | (83.45) |
| GP enMotion ® Paper Towels | 37.11 | 13.72 | 1188.36 |
| with 55% SPI Resin - 11 Sheets | (1.99) | (0.99) | (93.12) |

### Example 12

### Kleenex® Scottfold Paper Towel and SPI Composite

As with the other paper towels fabricated into composites, the Kleenex® Scottfold paper towels were also found to be absorbent. A composition of 60% SPI resin and 40% paper towel was reached after three impregnations. A single sheet was cured, as well as 11 sheets cured together, forming a composite. The mechanical properties of the Kleenex® Scottfold paper towel and SPI composite, as compared to the dry Kleenex® Scottfold paper towel (no resin) and the SPI+30% Phytagel® resin film can be found in Table 7.

TABLE 7
Tensile Properties of Kleenex ® Scottfold Paper Towel SPI Composite

| | Tensile | Tensile | Modulus |
|---|---|---|---|
| | Stress at | Strain | (Young's |
| | Max Load | at Max Load | 0.4-2.1%) |
| | (MPa) | (%) | (MPa) |
| SPI + 30% Phytagel ® Resin Film | 20.29 | 19.42 | 552.08 |
| | (2.49) | (3.25) | (60.37) |
| Kleenex ® Scottfold Paper | 5.01 | 9.24 | 130.05 |
| Towels | (0.58) | (1.04) | (12.15) |
| Kleenex ® Scottfold Paper | 11.71 | 8.00 | 582.32 |
| Towels w/ 60% SPI Resin - 1 | (1.20) | (1.30) | (25.92) |
| Sheet | | | |
| Kleenex ® Scottfold Paper | 29.47 | 20.02 | 891.51 |
| Towels w/ 60% SPI Resin - 11 | (2.98) | (1.80) | (55.04) |
| Sheets | | | |

### Example 13

### Cornell Daily Sun Newspaper and SPI Composite

The Cornell Daily Sun (CDS) newspaper was not found to be as absorbent; it took several more impregnations than the paper towels to achieve the desired composition of resin. The newspaper was impregnated eight times and reached a composition of 65% SPI resin and 35% newspaper. A single sheet was cured, as well as 15 sheets together, forming a composite. The mechanical properties of the CDS newspaper and SPI composite, as compared to the dry CDS newspaper (no resin) and the SPI+30% Phytagel® resin film can be found in Table 8.

TABLE 8
Tensile Properties of CDS Newspaper SPI Composite

| | Tensile | Tensile | Modulus |
|---|---|---|---|
| | Stress at | Strain | (Young's |
| | Max Load | at Max Load | 0.4-2.1%) |
| | (MPa) | (%) | (MPa) |
| SPI + 30% Phytagel ® Resin Film | 20.29 | 19.42 | 552.08 |
| | (2.49) | (3.25) | (60.37) |
| CDS Newspaper (No Resin) | 6.25 | 2.44 | 455.68 |
| | (1.22) | (0.90) | (52.38) |
| CDS Newspaper with 65% SPI | 28.05 | 4.15 | 1560.77 |
| Resin - 1 Sheet | (3.14) | (0.89) | (155.02) |
| CDS Newspaper with 65% SPI | 36.35 | 8.22 | 1363.28 |
| Resin - 15 Sheets | (4.14) | (2.09) | (195.77) |

### Example 14

### Comparison of Recycled Paper Product Composites with SPI Resin

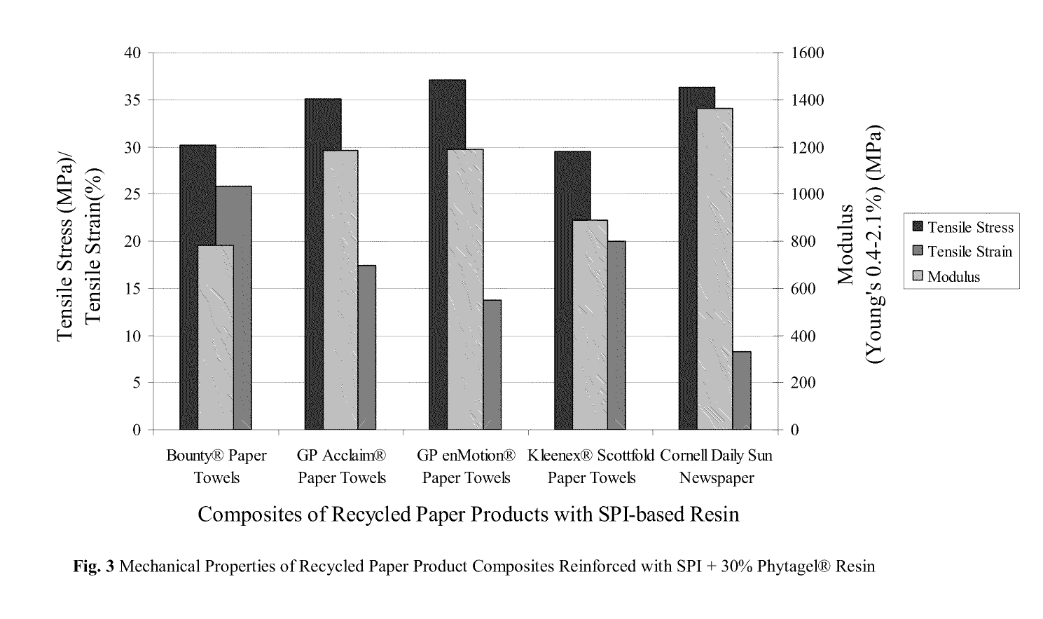

The compilation of mechanical properties of the composites obtained from the recycled paper product and SPI resin composites can be found in Table 9, as well as compared in FIG. 3. It was determined that all five paper products produced acceptable “green” composites. However, the composites made with GP Acclaim® paper towels, GP enMotion® paper towels and CDS newspaper exhibited the best mechanical properties. These composites, as compared to the Bounty® paper towels and Kleenex® Scottfold paper towels, had the highest tensile stress results and highest modulus results. Additionally, they had lower tensile strain results, indicating that the composites will deform less under stress.

TABLE 9
Comparison of Tensile Properties of Recycled Paper SPI Composites

| | | | | Modulus |
|---|---|---|---|---|
| | | Tensile Stress | Tensile Strain | (Young's |
| | Thickness | at Max Load | at Max Load | 0.4-2.1%) |
| | (mm) | (MPa) | (%) | (MPa) |
| Bounty ® Paper Towel w/ | 1.46 | 30.16 | 25.85 | 781.94 |
| 60% SPI Resin - 14 Sheets | (0.04) | (1.41) | (1.59) | (66.36) |
| GP Acclaim ® Paper Towels | 1.00 | 35.10 | 17.44 | 1183.50 |
| w/ 55% SPI Resin - 14 | (0.01) | (2.53) | (1.65) | (113.04) |
| Sheets | | | | |
| GP enMotion ® Paper | 0.80 | 37.11 | 13.72 | 1188.36 |
| Towels w/ 55% SPI Resin - | (0.01) | (1.99) | (0.99) | (93.12) |
| 11 Sheets | | | | |
| Kleenex ® Scottfold Paper | 1.09 | 29.47 | 20.02 | 891.51 |
| Towels w/ 60% SPI Resin - | (0.03) | (2.98) | (1.80) | (55.04) |
| 11 Sheets | | | | |
| CDS Newspaper w/ 65% | 2.52 | 36.35 | 8.22 | 1363.28 |
| SPI Resin - 15 Sheets | (0.19) | (4.14) | (2.09) | (195.77) |

### Example 15

### Starch Resins

Initially, starch based resins were prepared using TG, MG, PG, TGS, MGS or PGS with no plasticizer. 50 times the amount of starch of distilled water (50 mL per 1 g of starch) was added to the starch and the resin film was created as described above. However, these films were extremely brittle and were not tested. In addition, some resin films were too brittle to withstand the pressure during the curing (hot-press) and cracked into many pieces during this process. The plasticizer sorbitol was then added to the starch powder during the pre-curing process to provide greater strength to the resin. The resin film was then hot-pressed at a temperature of 110° C. for 15 minutes.

The tensile results of the six starches with varying amounts of sorbitol can be found in Table 10. The results are shown as the mean, with the standard deviation in italics. Many of the resin strips were extremely brittle and had cracks within the strips prior to tensile testing, therefore not giving acceptable results for mechanical testing. The results in bold-face type indicate that there were no cracks prior to tensile testing.

TABLE 10
Tensile Properties of Starch Resin Composites Having Varying
Amounts of Sorbitol

| | Tensile | Tensile | Modulus |
|---|---|---|---|
| | Stress at | Strain at | (Young's |
| | Max Load | Max Load | 0.4-2.1%) |
| | (MPa) | (%) | (MPa) |
| TG + 0% Sorbitol | 13.47 | 0.89 | — |
| | (6.56) | (0.39) | |
| TG + 10% Sorbitol | 24.08 | 2.72 | 1258.2 |
| | (1.71) | (0.33) | (120.56)* |
| TG + 20% Sorbitol | 4.49 | 0.50 | — |
| | (NA) | (NA) | |
| TG + 30% Sorbitol | 4.47 | 33.17 | 95.25 |
| | [symbol] | [symbol] | [symbol] |
| MG + 0% Sorbitol | 27.08 | 1.83 | 2302.71 |
| | (4.23) | (0.40) | (298.61)* |
| MG + 10% Sorbitol | 22.89 | 2.46 | 1330.78 |
| | (5.04) | (0.64) | (224.07) |
| MG + 20% Sorbitol | 20.89 | 2.62 | 1159.15 |
| | [symbol] | [symbol] | [symbol] |
| MG + 30% Sorbitol | 1.59 | 4.67 | 73.28 |
| | [symbol] | [symbol] | [symbol] |
| PG + 0% Sorbitol | 21.78 | 1.20 | — |
| | (9.97) | (0.63) | |
| PG + 10% Sorbitol | 19.16 | 1.54 | 1691.81 |
| | (6.55) | (0.39) | (224.76)* |
| PG + 20% Sorbitol | 13.06 | 2.00 | 912.92 |
| | [symbol] | [symbol] | [symbol] |
| PG + 30% Sorbitol | 1.39 | 3.67 | 74.74* |
| | (NA) | (NA) | |
| TGS + 0% Sorbitol | 8.55 | 0.87 | — |
| | (1.68) | (0.22) | |
| TGS + 10% Sorbitol | 4.67 | 1.62 | — |
| | (1.35) | (0.32) | |
| TGS + 20% Sorbitol | 4.18 | 15.45 | 163.36 |
| | [symbol] | [symbol] | [symbol] |
| TGS + 30% Sorbitol | 2.11 | 11.14 | 69.51 |
| | [symbol] | [symbol] | [symbol] |
| MGS + 0% Sorbitol | 21.42 | 1.57 | 1793.90 |
| | [symbol] | [symbol] | [symbol] |
| MGS + 10% Sorbitol | 5.65 | 1.13 | 635.77 |
| | [symbol] | [symbol] | [symbol] |
| MGS + 20% Sorbitol | 2.70 | 5.42 | 130.00 |
| | [symbol] | [symbol] | [symbol] |
| MGS + 30% Sorbitol | — | — | — |
| PGS + 0% Sorbitol | 6.33 | 0.62 | — |
| | (2.30) | (0.16) | |
| PGS + 10% Sorbitol | 12.69 | 1.21 | 1316.17 |
| | [symbol] | [symbol] | [symbol] |
| PGS + 20% Sorbitol | — | — | — |
| PGS + 30% Sorbitol | 2.30 | 10.80 | 93.42 |
| | [symbol] | [symbol] | [symbol] |

Note:
(NA) indicates not available

The * in Table 10 denotes the modulus is automatic modulus, rather than Young's modulus. For these samples, the tensile strain was too low (the sample was too brittle) for the Young's modulus to be measured. This occurs when the strain does not reach 0.4-2.1%. Additionally, as seen in Table 10, MGS+30% sorbitol and PGS+20% sorbitol were unable to be tested.

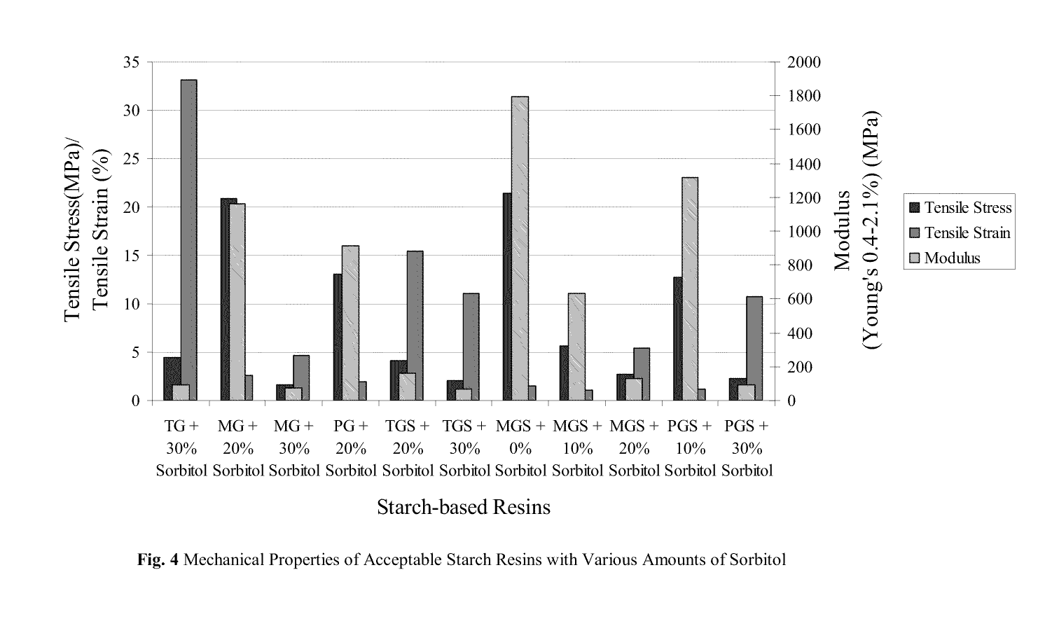

The specimens listed in bold in Table 10 all had acceptable results from the tensile test as performed on the Instron machine. These results have been compiled into Table 11 and FIG. 4. As with Table 10, these results are denoted with * to demonstrate the automatic modulus.

TABLE 11
Tensile and Modulus Properties of Starch Resin Composites Having
Varying Amounts of Sorbitol

| | Tensile Stress at | Tensile Strain at | Modulus (Young's |
|---|---|---|---|
| | Max Load | Max Load | 0.4-2.1%) |
| | (MPa) | (%) | (MPa) |
| TG + 30% Sorbitol | 4.47 (0.32) | 33.17 (4.02) | 95.25 (14.83) |
| MG + 20% Sorbitol | 20.89 (1.13) | 2.62 (0.33) | 1159.15 (69.59) |
| MG + 30% Sorbitol | 1.59 (0.56) | 4.67 (1.31) | 73.28 (22.72) |
| PG + 20% Sorbitol | 13.06 (3.82) | 2.00 (0.45) | 912.92 (96.81) |
| TGS + 20% Sorbitol | 4.18 (0.38) | 15.45 (2.46) | 163.36 (15.29) |
| TGS + 30% Sorbitol | 2.11 (0.26) | 11.14 (2.34) | 69.51 (12.90) |
| MGS + 0% Sorbitol | 21.42 (6.95) | 1.57 (0.42) | 1793.90 (248.83)* |
| MGS + 10% Sorbitol | 5.65 (2.50) | 1.13 (0.44) | 635.77 (46.33)* |
| MGS + 20% Sorbitol | 2.70 (0.27) | 5.42 (1.00) | 130.00 (10.27) |
| PGS + 10% Sorbitol | 12.69 (2.42) | 1.21 (0.25) | 1316.17 (112.89)* |
| PGS + 30% Sorbitol | 2.30 (0.46) | 10.80 (4.10) | 93.42 (18.54) |

It was determined that MG+20% sorbitol and MGS+0% sorbitol had the best mechanical properties, as seen by having the highest tensile stress and modulus. These results were compared to the SPI+30% Phytagel® resin, as can be seen in Table 12 and FIG. 5.

TABLE 12
Comparison of Tensile Properties of Sorbitol- and Phytagel ®-
Containing Resins

| | Tensile | Tensile | Modulus |
|---|---|---|---|
| | Stress at | Strain at | (Young's |
| | Max Load | Max Load | 0.4-2.1%) |
| | (MPa) | (%) | (MPa) |
| SPI + 30% | 20.29 | 19.42 | 552.08 |
| Phytagel ® | (2.49) | (3.25) | (60.37) |
| MG + 20% Sorbitol | 20.89 | 2.62 | 1159.15 |
| | (1.13) | (0.33) | (69.59) |
| MGS + 0% Sorbitol | 21.42 | 1.57 | 1793.90 |
| | (6.95) | (0.42) | (248.83)* |

As seen in FIG. 5, SPI+30% Phytagel®, which was the SPI resin with the best mechanical properties, had a similar tensile stress to MG+20% sorbitol and MGS+0% sorbitol. However, the modulus is significantly higher for the starch-based resins as compared to the SPI-based resin, therefore demonstrating improved properties for the starch-based resins. Additionally, the SPI-based resin had a very high tensile strain, which leads to a high deformation, as compared to the starch-based resins. When comparing MG+20% sorbitol to MGS+0% sorbitol, MGS+0% sorbitol has better mechanical properties because it has a higher tensile stress and higher modulus. Additional plasticizer slightly decreases the tensile stress and modulus, but increases the tensile strain, resulting in resins which can be handled without breaking.

### Example 16

### Starch Resins Modified with Thickeners

CMG, CMS and CMT thickeners were added to the MG and MGS starch resins, as described above, because MG and MGS were found to have the best mechanical properties as compared to the other starches tested. These three plasticizers were added in incremental amounts of 10%, 20% and 30% by weight of the starch. The recipe for the addition of the new thickener was: 7.0 g of starch (MG or MGS)+0.7 g, 1.4 g, or 2.1 g (10%, 20%, or 30%, respectively) of thickener (CMG, CMS, or CMT)+350 mL (50 mL per 1 g of starch) of distilled water. The dry starch and thickener powders were mixed by hand thoroughly before the addition of water because the plasticizers thickened upon the addition of water, therefore making dispersion difficult. When stirred in an 80° C. water bath the viscosity of the solution decreased and an evenly dispersed resin formed.

The results for the addition of CMT to MG and MGS can be found in Table 13 (* denotes automatic modulus due to the low tensile strain).

TABLE 13
Tensile Properties for CMT-Containing Starch Resins

| | Tensile | Tensile | Modulus |
|---|---|---|---|
| | Stress at | Strain at | (Young's |
| | Max Load | Max Load | 0.4-2.1%) |
| | (MPa) | (%) | (MPa) |
| MG + 0% CMT | 20.89 | 2.62 | 1159.15 |
| | (1.13) | (0.33) | (69.59) |
| MG + 10% CMT | 6.86 | 0.92 | — |
| | (1.28) | (0.35) | |
| MG + 20% CMT | 14.24 | 1.42 | 1298.98* |
| | (5.60) | (0.22) | (288.40) |
| MG + 30% CMT | 15.25 | 1.71 | 1188.23 |
| | (5.26) | (0.69) | (88.65) |
| MGS + 0% CMT | 21.42 | 1.57 | 1793.90 |
| | (6.95) | (0.42) | (248.83)* |
| MGS + 10% CMT | 2.20 | 0.67 | 11.79 |
| | (1.04) | (0.17) | (2.63) |
| MGS + 20% CMT | 9.63 | 1.25 | 894.71* |
| | (0.17) | (0.12) | (50.73) |
| MGS + 30% CMT | 12.31 | 1.81 | 1074.24 |
| | [symbol] | [symbol] | [symbol] |

The addition of CMG resulted in improved mechanical properties of the starch resin. The tensile testing results for the addition of CMG to the starch resins can be found in Table 14.

TABLE 14
Tensile Properties for CMG-Containing Starch Resins

| | Tensile | Tensile | Modulus |
|---|---|---|---|
| | Stress at | Strain at | (Young's |
| | Max Load | Max Load | 0.4-2.1%) |
| | (MPa) | (%) | (MPa) |
| MG + 0% CMG | 20.89 | 2.62 | 1159.15 |
| | (1.13) | (0.33) | (69.59) |
| MG + 10% CMG | — | — | — |
| MG + 20% CMG | 7.41 | 0.73 | 42.08 |
| | (4.64) | (0.33) | (41.06) |
| MG + 30% CMG | 7.52 | 0.73 | 6.96 |
| | (3.36) | (0.45) | (5.82) |
| MGS + 0% CMG | 21.42 | 1.57 | 1793.90 |
| | (6.95) | (0.42) | (248.83)* |
| MGS + 10% CMG | 4.72 | 0.72 | — |
| | (1.76) | (0.25) | |
| MGS + 20% CMG | 13.39 | 1.43 | 1345.90 |
| | (7.61) | (0.45) | (612.60) |
| MGS + 30% CMG | 19.01 | 1.36 | 1951.43 |
| | (2.80) | (0.24) | (114.40) |

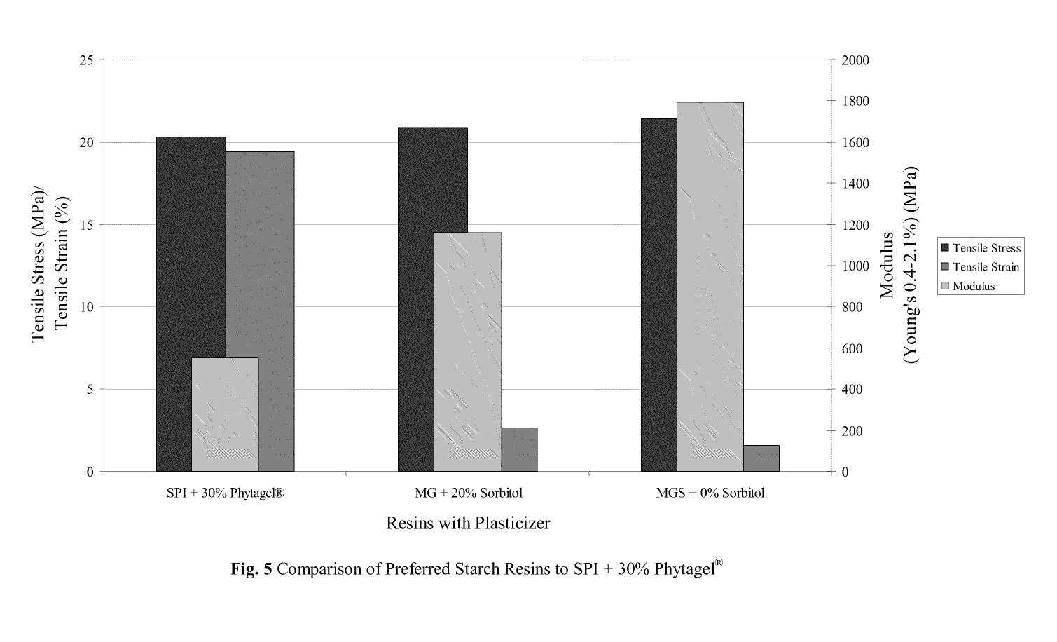

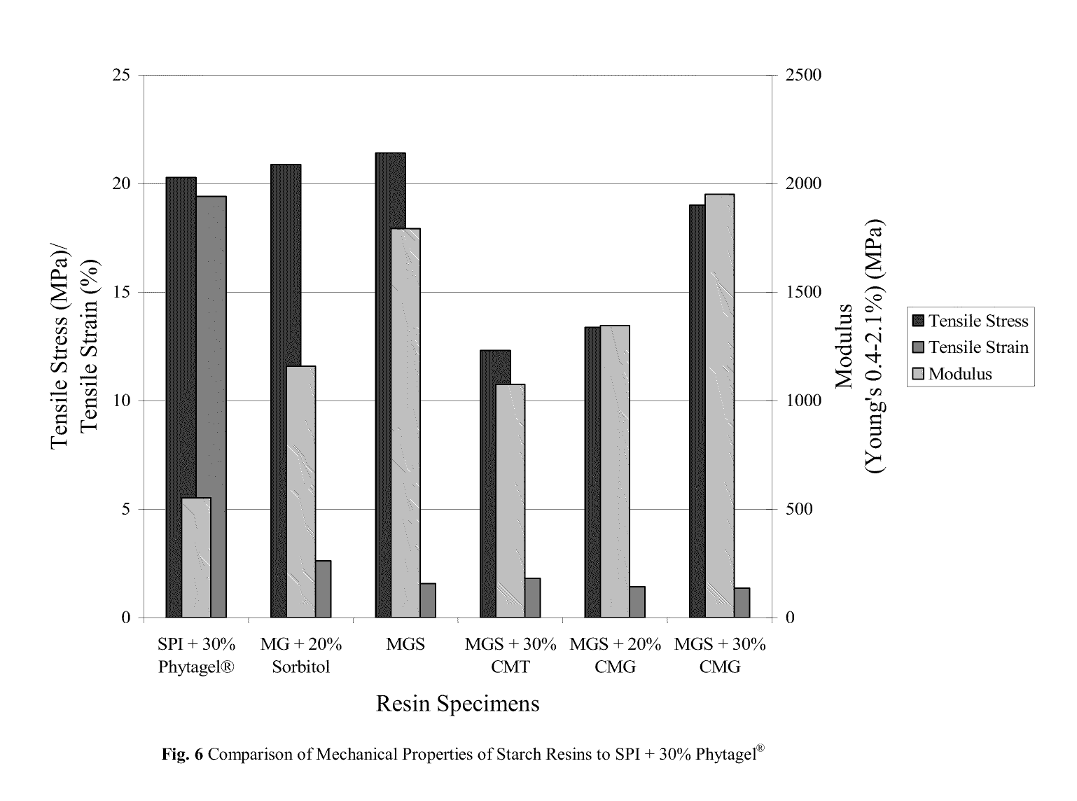

The remaining starch resin samples prepared can be found in Table 15 and are compared to SPI+30% Phytagel®. These results are compared in FIG. 6.

TABLE 15
Optimization of Starch Resin Additives Based on Tensile Properties

| | Tensile | Tensile | Modulus |
|---|---|---|---|
| | Stress at | Strain at | (Young's |
| | Max Load | Max Load | 0.4-2.1%) |
| | (MPa) | (%) | (MPa) |
| SPI + 30% | 20.29 | 19.42 | 552.08 |
| Phytagel ® | (2.49) | (3.25) | (60.37) |
| MG + 20% Sorbitol | 20.89 | 2.62 | 1159.15 |
| | (1.13) | (0.33) | (69.59) |
| MGS | 21.42 | 1.57 | 1793.90* |
| | (6.95) | (0.42) | (248.83) |
| MGS + 30% CMT | 12.31 | 1.81 | 1074.24 |
| | (1.96) | (0.25) | (168.56) |
| MGS + 20% CMG | 13.39 | 1.43 | 1345.90 |
| | (7.61) | (0.45) | (612.60) |
| MGS + 30% CMG | 19.01 | 1.36 | 1951.43 |
| | (2.80) | (0.24) | (114.40) |

As seen in Table 15 and FIG. 6, the best mechanical properties were obtained from MGS+30% CMG. The tensile stress (19.01 MPa) is not higher than SPI+30% Phytagel®, MG+20% sorbitol or MGS without a plasticizer. However, the modulus of MGS+30% CMG (1951.43 MPa) is significantly higher than the rest of the resin films. The addition of 30% CMG enhanced the mechanical properties of the MGS because the CMG was thick enough to improve the tensile properties, but not too thick to create a viscosity that does not allow the resin to form properly, as seen with the addition of CMS and CMT.

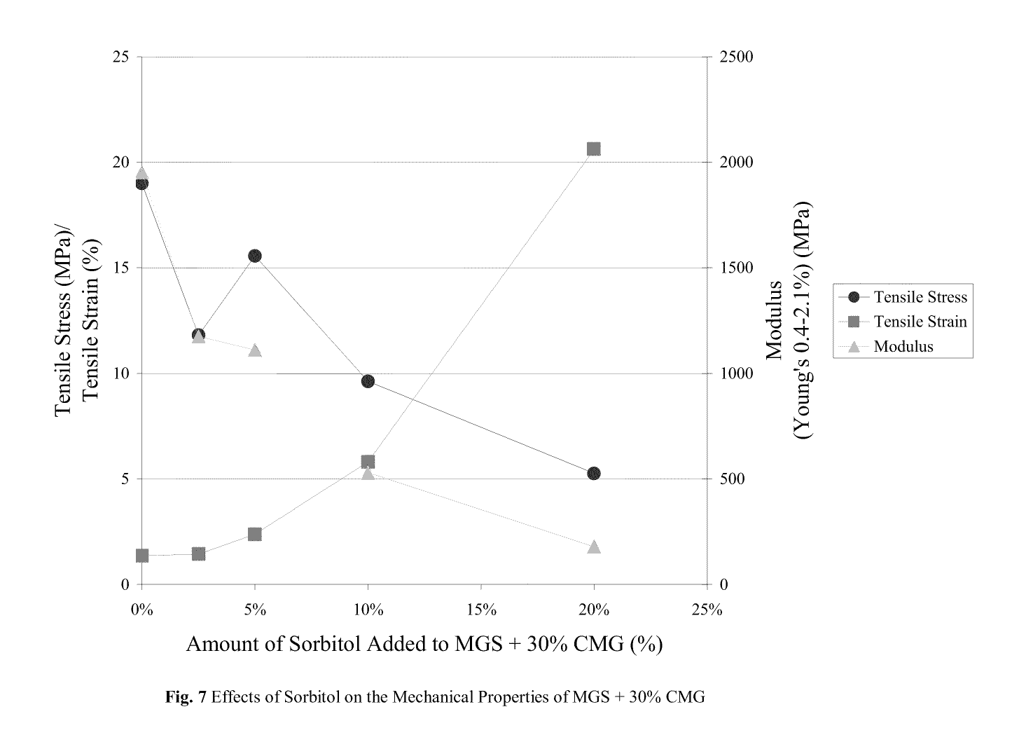

MGS+30% CMG was chosen to be used in the recycled paper composites reinforced with starch-based resin. To increase the ductility, sorbitol was added to MGS+30% CMG. The tensile properties can be found in Table 16 and compared in FIG. 7.

TABLE 16
Varying Amounts of Sorbitol in MGS + 30% CMG Resin

| | Tensile | Tensile | Modulus |
|---|---|---|---|
| | Stress at | Strain at | (Young's |
| | Max Load | Max Load | 0.4-2.1%) |
| | (MPa) | (%) | (MPa) |
| MGS + 30% CMG + | 19.01 | 1.36 | 1951.43 |
| 0% Sorbitol | (2.80) | (0.24) | (114.40) |
| MGS + 30% CMG + | 11.81 | 1.44 | 1175.54 |
| 2.5% Sorbitol | (0.88) | (0.10) | (129.12) |
| MGS + 30% CMG + | 15.57 | 2.38 | 1111.33 |
| 5% Sorbitol | (1.23) | (0.37) | (68.31) |
| MGS + 30% CMG + | 9.63 | 5.81 | 529.65 |
| 10% Sorbitol | (0.73) | (1.18) | (55.12) |
| MGS + 30% CMG + | 5.27 | 20.62 | 178.73 |
| 20% Sorbitol | (0.89) | (7.04) | (13.41) |

Recycled Paper Products with Starch-Based Resins

GP Acclaim® paper towels, the GP enMotion® paper towels and the Cornell Daily Sun newspaper were made into composites using a resin comprising MGS+30% CMG+5% sorbitol and MGS+30% CMG+10% sorbitol. The number of times necessary to impregnate the paper products in order to reach a desired composition of starch resin has increased from the SPI+30% Phytagel® resin because a greater amount of water is needed to decrease the viscosity of the starch resin. The mechanical properties of the dry paper towels have been presented in Table 1.

### Example 18

### Georgia-Pacific Acclaim® Paper Towel and Starch-Based Composite

The GP Acclaim® paper towel composite was prepared using a resin comprising MGS+30% CMG+5% sorbitol. Four impregnations were required to produce the desired ratio of 45% resin and 55% paper towel. A single sheet was cured, as well as 7 sheets cured together, forming a composite. The mechanical properties of the GP Acclaim® paper towel and MGS+30% CMG+5% sorbitol, as compared to the dry GP Acclaim® paper towel (no resin) and the MGS+30% CMG+5% sorbitol resin film can be found in Table 17.

The GP Acclaim® paper towel composite was also prepared using a resin comprising MGS+30% CMG+10% sorbitol. Four impregnations were required to produce the desired ratio of 45% resin and 55% paper towel. A single sheet was cured, and in addition 7 sheets were cured together, forming a composite. The mechanical properties of the GP Acclaim® paper towel and MGS+30% CMG+10% sorbitol can be found in Table 17, as compared to the composite using MGS+30% CMG+5% sorbitol, the GP Acclaim® paper towels with no resin and the MGS+30% CMG+10% resin.

TABLE 17
GP Acclaim ® Paper Towel and Starch-Based Resin Composite

| | Tensile | Tensile | Modulus |
|---|---|---|---|
| | Stress at | Strain at | (Young's |
| | Max Load | Max Load | 0.4-2.1%) |
| | (MPa) | (%) | (MPa) |
| MGS + 30% CMG + | 15.57 | 2.38 | 1111.33 |
| 5% Sorbitol | (1.23) | (0.37) | (68.31) |
| MGS + 30% CMG + | 9.63 | 5.81 | 529.65 |
| 10% Sorbitol | (0.73) | (1.18) | (55.12) |
| GP Acclaim ® Paper | 2.50 | 3.38 | 135.33 |
| Towels (dry) | (0.38) | (1.03) | (20.64) |
| GP Acclaim ® Paper | 32.96 | 15.60 | 888.76 |
| Towels with MGS + | (2.51) | (1.26) | (186.71) |
| 30% CMG + 5% | | | |
| Sorbitol - 1 Sheet | | | |
| GP Acclaim ® Paper | 34.11 | 12.86 | 1627.37 |
| Towels with MGS + | (2.79) | (1.05) | (107.15) |
| 30% CMG + 5% | | | |
| Sorbitol - 7 Sheets | | | |
| GP Acclaim ® Paper | 13.48 | 6.96 | 799.55 |
| Towels with MGS + | (1.67) | (1.30) | (84.53) |
| 30% CMG + 10% | | | |
| Sorbitol - 1 Sheet | | | |
| GP Acclaim ® Paper | 26.30 | 16.17 | 1046.23 |
| Towels with MGS + | (1.55) | (2.94) | (86.99) |
| 30% CMG + 10% | | | |
| Sorbitol - 7 Sheets | | | |

### Example 20

### Georgia-Pacific enMotion® Paper Towel and Starch-Based Composites

The GP enMotion® paper towel was first created using the MGS+30% CMG+5% sorbitol resin. Four impregnations were required to produce the desired ratio of 46% resin and 54% paper towel. A single sheet was cured, as well as 7 sheets cured together, forming a composite. The mechanical properties of the GP enMotion® paper towel and MGS+30% CMG+5% sorbitol, as compared to the dry GP enMotion® paper towel (no resin) and the MGS+30% CMG+5% sorbitol resin film can be found in Table 18.

Following the impregnation of GP enMotion® paper towels using MGS+30% CMG+5% sorbitol, GP enMotion® paper towels were impregnated using MSG+30% CMG+10% sorbitol. Four impregnations were required to produce the desired ratio of 46% resin and 54% paper towel. A single sheet was cured, as well as 7 sheets cured together, forming a composite. The mechanical properties of the GP enMotion® paper towel and MGS+30% CMG+10% sorbitol can be found in Table 18, as compared to the composite using MGS+30% CMG+5% sorbitol, the GP enMotion® paper towels with no resin and the MGS+30% CMG+10% resin.

TABLE 18
GP enMotion ® Paper Towel and Starch-Based Resin
Composite

| | Tensile | Tensile | Modulus |
|---|---|---|---|
| | Stress at | Strain at | (Young's |
| | Max Load | Max Load | 0.4-2.1%) |
| | (MPa) | (%) | (MPa) |
| MGS + 30% CMG + | 15.57 | 2.38 | 1111.33 |
| 5% Sorbitol | (1.23) | (0.37) | (68.31) |
| MGS + 30% CMG + | 9.63 | 5.81 | 529.65 |
| 10% Sorbitol | (0.73) | (1.18) | (55.12) |
| GP enMotion ® | 6.13 | 3.08 | 372.99 |
| Paper Towels (dry) | (0.90) | (0.45) | (66.20) |
| GP enMotion ® | 19.06 | 6.80 | 954.20 |
| Paper Towels with | (2.77) | (1.10) | (231.44) |
| MGS + 30% CMG + | | | |
| 5% Sorbitol - 1 | | | |
| Sheet | | | |
| GP enMotion ® | 48.98 | 10.79 | 2100.06 |
| Paper Towels with | (6.70) | (1.01) | (288.95) |
| MGS + 30% CMG + | | | |
| 5% Sorbitol - 7 | | | |
| Sheets | | | |
| GP enMotion ® | 12.29 | 6.85 | 628.35 |
| Paper Towels with | (1.94) | (1.18) | (54.49) |
| MGS + 30% CMG + | | | |
| 10% Sorbitol - 1 | | | |
| Sheet | | | |
| GP enMotion ® | 28.67 | 10.86 | 1112.27 |
| Paper Towels with | (4.01) | (1.59) | (94.12) |
| MGS + 30% CMG + | | | |
| 10% Sorbitol - 7 | | | |
| Sheets | | | |

### Example 21

### Cornell Daily Sun Newspaper and Starch-Based Composite

The CDS newspaper composite was first fabricated using the MGS+30% CMG+5% sorbitol resin. Five impregnations were required to produce the desired ratio of 43% resin and 57% paper towel. A single sheet was cured, followed by 7 sheets cured together, forming a composite. The mechanical properties of the CDS newspaper and MGS+30% CMG+5% sorbitol, as compared to the dry CDS newspaper (no resin) and the MGS+30% CMG+5% sorbitol resin film can be found in Table 19.

Following the impregnation of CDS newspaper using MGS+30% CMG+5% sorbitol, CDS newspaper sheets were impregnated using MSG+30% CMG+10% sorbitol. Five impregnations were required to produce the desired ratio of 43% resin and 57% paper towel. A single sheet was cured, as well as 7 sheets cured together, forming a composite. The mechanical properties of the CDS newspaper and MGS+30% CMG+10% sorbitol can be found in Table 19, as compared to the composite using MGS+30% CMG+5% sorbitol, the CDS newspaper with no resin and the MGS+30% CMG+10% resin.

TABLE 19
CDS Newspaper and Starch-Based Resin Composite

| | Tensile | Tensile | Modulus |
|---|---|---|---|
| | Stress at | Strain at | (Young's |
| | Max Load | Max Load | 0.4-2.1%) |
| | (MPa) | (%) | (MPa) |
| MGS + 30% CMG + | 15.57 | 2.38 | 1111.33 |
| 5% Sorbitol | (1.23) | (0.37) | (68.31) |
| MGS + 30% CMG + | 9.63 | 5.81 | 529.65 |
| 10% Sorbitol | (0.73) | (1.18) | (55.12) |
| CDS newspaper | 6.25 | 2.44 | 455.68 |
| (dry) | (1.22) | (0.90) | (52.38) |
| CDS newspaper | 14.67 | 2.81 | 1206.61 |
| with MGS + 30% | (1.82) | (0.69) | (109.67) |
| CMG + 5% Sorbitol - | | | |
| 1 Sheet | | | |
| CDS newspaper | 38.60 | 6.86 | 1612.66 |
| with MGS + 30% | (1.38) | (0.58) | (150.25) |
| CMG + 5% Sorbitol - | | | |
| 7 Sheets | | | |
| CDS newspaper | 45.61 | 5.08 | 2021.71 |
| with MGS + 30% | (4.33) | (0.62) | (79.27) |
| CMG + 10% | | | |
| Sorbitol - 1 Sheet | | | |
| CDS newspaper | 51.70 | 7.67 | 1589.86 |
| with MGS + 30% | (4.33) | (1.51) | (112.47) |
| CMG + 10% | | | |
| Sorbitol - 7 Sheets | | | |

### Example 22

### Comparison of Recycled Paper Product and Starch-Based Resin Composites

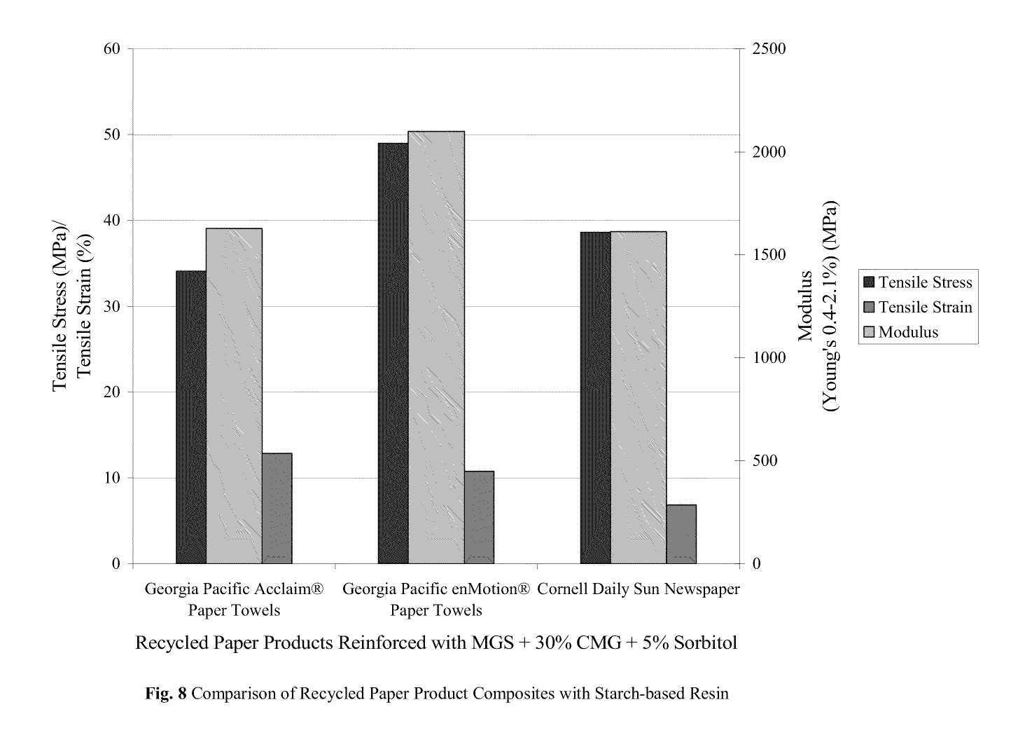

The comparison between the composites made with GP Acclaim® paper towels, GP enMotion® paper towels and CDS newspaper with MGS+30% CMG+5% sorbitol can be found in Table 20 and FIG. 8. All three of these composites produced excellent mechanical properties. However, the best mechanical properties were obtained from GP enMotion® paper towels, which had the highest tensile stress (48.98 MPa) and highest modulus (2100.06 MPa).

TABLE 20
Comparison of Recycled Paper Product and Starch-Based Resin
Composites

| | | Tensile | Tensile | Modulus |
|---|---|---|---|---|
| | | Stress | Strain at | (Young's |
| | Thickness | at Max Load | Max Load | 0.4-2.1%) |
| | (mm) | (MPa) | (%) | (MPa) |
| GP Acclaim ® Paper | 0.39 | 34.11 | 12.86 | 1627.37 |
| Towels with MGS + | (0.01) | (2.79) | (1.05) | (107.15) |
| 30% CMG + 5% | | | | |
| Sorbitol - 7 Sheets | | | | |
| GP enMotion ® | 0.37 | 48.98 | 10.79 | 2100.06 |
| Paper Towels with | (0.01) | (6.70) | (1.01) | (288.95) |
| MGS + 30% CMG + | | | | |
| 5% Sorbitol - 7 | | | | |
| Sheets | | | | |
| CDS Newspaper | 0.51 | 38.60 | 6.86 | 1612.66 |
| with MGS + 30% | (0.03) | (1.38) | (0.58) | (150.25) |
| CMG + 5% Sorbitol - | | | | |
| 7 Sheets | | | | |

Comparison of Composites Produced with Modified SPI and Modified Starch

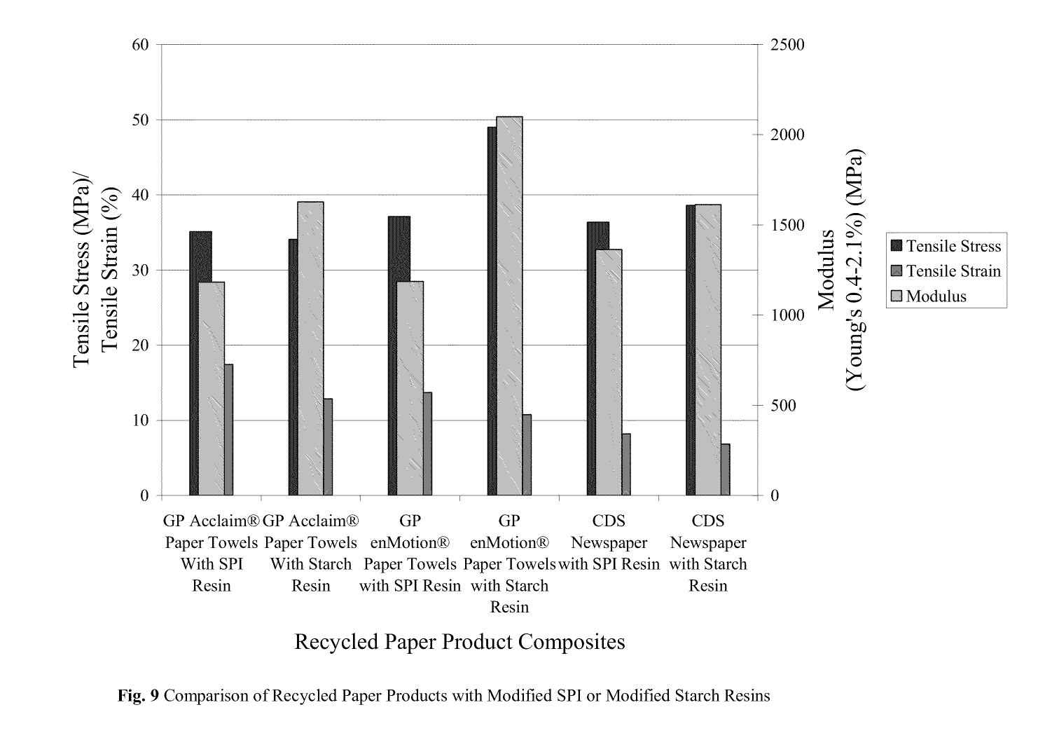

The mechanical properties of the modified starch resins were superior to those of modified SPI resins, as described above. A comparison of composites comprising recycled paper products and either SPI or starch resins can be found in Table 21 and FIG. 9. As seen in these comparisons, when comparing the same paper product for the two different resins, the modulus is higher for the modified starch resin. Additionally, the tensile strain is lower for the composite with the modified starch than with the modified SPI. The tensile stress is relatively similar for the composites with the two different resins, but there is a slight trend towards a higher tensile stress with the modified starch resin. Based on the comparison of the composites produced with the two different resins, the recycled paper product composites with the modified starch resin exhibit the best mechanical properties.

TABLE 21
Comparison of Composites Produced with Modified SPI and
Modified Starch

| | Tensile | Tensile | Modulus |
|---|---|---|---|
| | Stress at | Strain | (Young's |
| | Max Load | at Max Load | 0.4-2.1%) |
| | (MPa) | (%) | (MPa) |
| GP Acclaim ® Paper Towels/SPI | 35.10 | 17.44 | 1183.50 |
| Resin - 14 Sheets | (2.53) | (1.65) | (113.04) |
| GP Acclaim ® Paper | 34.11 | 12.86 | 1627.37 |
| Towels/Starch Resin - 7 Sheets | (2.79) | (1.05) | (107.15) |
| GP enMotion ® Paper Towels/SPI | 37.11 | 13.72 | 1188.36 |
| Resin - 11 Sheets | (1.99) | (0.99) | (93.12) |
| GP enMotion ® Paper | 48.98 | 10.79 | 2100.06 |
| Towels/Starch Resin - 7 Sheets | (6.70) | (1.01) | (288.95) |
| CDS Newspaper/SPI Resin - 15 | 36.35 | 8.22 | 1363.28 |
| Sheets | (4.14) | (2.09) | (195.77) |
| CDS Newspaper/Starch Resin - | 38.60 | 6.86 | 1612.66 |
| 7 Sheets | (1.38) | (0.58) | (150.25) |

What is claimed is:

1. A biodegradable composition comprising lignocellulosic reinforcement material impregnated with a starch based resin and cured to form a thermoset composition.

2. The biodegradable composition of claim 1, further comprising a strengthening agent.

3. The biodegradable composition of claim 1, wherein the strengthening agent is selected from the group consisting of nanoclay, microfibrillated cellulose, nanofibrillated cellulose and combinations thereof.

4. The biodegradable composition of claim 1, wherein the starch based resin is selected from the group consisting of corn starch, wheat starch, tapioca starch, tuber starch rice starch and combinations thereof.

5. The biodegradable polymeric composition of claim 4, wherein the tuber starch is selected from potato starch, sweet potato starch, yam starch or cassava starch.

6. The biodegradable composition of claim 1 where the lignocellulosic reinforcement material comprises fibers of selected from kenaf, jute, flax, linen, hemp and bamboo.

7. The biodegradable composition of claim 1, wherein the lignocellulosic reinforcement material is paper.

8. The biodegradable composition of claim 7, wherein the paper is selected from acid-free paper, bleach-free paper, recycled paper, paper by-products, mill broke, newspaper, magazines, fliers, post-consumer waste products, paper towels, napkins, tissues, and paper plates, cardboard, packaging materials, construction paper, recycled paper-containing products, paper bags, stationary, envelopes, corrugated cardboard, office products, printer paper, folders and shredded paper.

9. The biodegradable composition of claim 7, wherein the lignocellulosic reinforcement material is in the form of a non-woven fabric, yarn, non-woven mats, woven fabric, knitted fabric and randomly oriented fibers.

10. The composite of claim 9, wherein the non-woven mats are selected from needle-punched, wetlaid and air-laid mats comprises reinforcing fibers, reinforcing filaments or reinforcing yarns and/or green reinforcing woven or knitted fabric or non-woven fabric.

11. The composition of claim 1, where the strengthening agent is a polysaccharide and is selected from the group consisting of agar, gellan gum and mixtures thereof.

12. The composition of claim 1, wherein the starch further comprises a plasticizer.

13. The composition of claim 12, wherein the plasticizer further comprises a polyol.

14. The composition of claim 1, wherein the starch based resin comprises a glycol stearate containing starch based resin.

15. The composition of claim 14, wherein the starch based resin is a glycol stearate containing starch based resin selected from the group consisting of glycol stearate containing corn starch, glycol stearate containing wheat starch, glycol stearate containing tapioca starch, glycol stearate containing tuber starch, glycol stearate containing rice starch and combinations thereof.

16. The composition of claim 12, wherein the plasticizer is selected from carboxyl methyl gum, carboxyl methyl starch and carboxy methyl tamarind.

17. The composition of claim 12, wherein the plasticizer comprises glycerol.

18. A method of making a biodegradable composition comprising:
providing a lignocellulosic reinforcement material;
impregnating the lignocellulosic reinforcement material with starch based resin to create an impregnated lignocellulosic reinforcement material;
drying the impregnated lignocellulosic reinforcement material;
curing the lignocellulosic reinforcement material at a sufficient temperature and a sufficient pressure for a sufficient period of time to produce a thermoset biodegradable composition.

19. The method of claim 18, further comprising a strengthening agent.

20. The method of claim 18, wherein the strengthening agent is selected from the group consisting of nanoclay, microfibrillated cellulose, nanofibrillated cellulose and combinations thereof.

21. The method of claim 18, wherein the sufficient temperature to form a composite is about 110° C. to about 140° C.

22. The method of claim 18, wherein the sufficient pressure is from about 0.001 tons to about 200 tons per square foot.

23. The method of claim 18, wherein the sufficient time is a minimum of about 5 min and a maximum of about 120 min.

24. The method of claim 1, wherein the starch based resin is selected from the group consisting of corn starch, wheat starch, tapioca starch, tuber starch, rice starch and combinations thereof.

25. The biodegradable polymeric composition of claim 4, wherein the tuber starch is selected from potato starch, sweet potato starch, yam starch or cassava starch.

26. The biodegradable composition of claim 18, where the lignocellulosic reinforcement material comprises fibers of selected from kenaf, jute, flax, linen, hemp and bamboo.

27. The biodegradable composition of claim 18, wherein the lignocellulosic reinforcement material is paper.

28. The biodegradable composition of claim 27, wherein the paper is selected from acid-free paper, bleach-free paper, recycled paper, paper by-products, mill broke, newspaper, magazines, fliers, post-consumer waste products, paper towels, napkins, tissues, and paper plates, cardboard, packaging materials, construction paper, recycled paper-containing products, paper bags, stationary, envelopes, corrugated cardboard, office products, printer paper, folders and shredded paper.

29. The method of claim 27, wherein the lignocellulosic reinforcement material is in the form of a non-woven fabric, yarn, non-woven mats, woven fabric, knitted fabric and randomly oriented fibers.

30. The method of claim 29, wherein the non-woven mats are selected from needle-punched, wetlaid and air-laid mats comprises reinforcing fibers, reinforcing filaments or reinforcing yarns and/or green reinforcing woven or knitted fabric or non-woven fabric.

31. The composition of claim 18, where the strengthening agent is a polysaccharide and is selected from the group consisting of agar, gellan gum and mixtures thereof.

32. The method of claim 18, wherein the starch further comprises a plasticizer.

33. The method of claim 32, wherein the plasticizer further comprises a polyol.

34. The method of claim 18, wherein the starch based resin comprises a glycol stearate containing starch based resin.

35. The composition of claim 14, wherein the starch based resin is a glycol stearate containing starch based resin selected from the group consisting of glycol stearate containing corn starch, glycol stearate containing wheat starch, glycol stearate containing tapioca starch, glycol stearate containing tuber starch, glycol stearate containing rice starch and combinations thereof.

36. The composition of claim 12, wherein the plasticizer is selected from carboxyl methyl gum, carboxyl methyl starch and carboxy methyl tamarind.

37. The composition of claim 12, wherein the plasticizer comprises glycerol.
